(19) United States
(12) Patent Application Publication
(10) Pub. No.: US 2026/0310521 A1
(43) Pub. Date: Oct. 8, 2026

(54) DETECTION OF NEW RESOURCE OBLIGATION RULES AND AUTHORIZATIONS IMPACTING RESOURCE CALCULATION AND REPORTING

(71) Applicant: Avalara, Inc., Seattle, WA (US)

(72) Inventors: Naveen Kumar Agrawal, Bellevue, WA (US); Thomas Goldschmidt, Karlsdorf-Neuthard (DE)

(21) Appl. No.: 19/173,642

(22) Filed: Apr. 8, 2025

(51) Int. Cl. G06F 9/50; H04L 9/40

(52) U.S. Cl. CPC G06F 9/5077; H04L 63/08

(57) ABSTRACT

Examples of systems described herein include online software platforms that may receive transaction data for an entity. The online software platform may calculate resource obligations associated with the transaction data. The online software platform may compare the resource obligations with historical resource obligations incurred by the entity. For example, historical resource obligations incurred by the entity may be stored in storage accessible to the online software platform. The online software platform may, based on the comparison, search for authorization to prepare data output. The comparison may indicate that at least one of the resource obligations is a new resource obligation for the entity. The online software platform may, responsive to accessing the authorization, prepare the data output for the new resource obligation.

### TECHNICAL FIELD

This application relates to software systems for performing resource calculations. Examples of systems may receive and/or detect a new resource obligation rule, may calculate new resource obligations corresponding to the new resource obligation rule, and may prepare data output for the new resource obligation responsive to an authorization.

### BACKGROUND

Traditionally, businesses and/or entities rely on systems that utilize data from various software services and other systems, such as invoicing software systems, to determine and/or calculate resource obligations (e.g., taxes and/or fees) for the business and/or entity. Oftentimes, these resource obligation calculations are based on corresponding resource obligation rules (e.g., tax amount, fee amount, tax rate, fee rate, etc.). Such obligation rules may be established by various authorities (e.g., tax authorities), and may be jurisdiction-specific. For example, each jurisdiction may have its own distinct and/or aggregate resource obligation rule(s) (e.g., tax rates, fee rates, etc.). Such obligation rules may further be based on a unique combination of factors, including sales taxes levied by taxing authorities at various jurisdiction levels, including but not limited to the state, county, city, and district levels.

The usefulness of these traditional systems, such as invoicing software systems, often hinges on the system’s ability to remain compliant with the obligation rules. Moreover, once a new resource obligation is calculated and collected, businesses and/or entities often struggle with accurately and timely reporting it to the appropriate authorities. Such traditional systems often fail because of their inability to remain current and compliant with resource obligation determination, collection, and reporting when presented with continuous updates to existing resource obligation rules and new resource obligation rules.

With the increasing frequency at which existing resource obligation rules change, and new resource obligation rules are introduced, navigating this complex landscape can be challenging for businesses and/or entities, especially considering the existence of differing regulations across different jurisdictions, including states and localities. As such, the compliance and reporting benefits of a system that automatically recognizes and calculates new resource obligations and assists in fulfilling any reporting needs would be immense.

All subject matter discussed in this Background section of this document is not necessarily prior art, and may not be presumed to be prior art simply because it is presented in this Background section. Plus, any reference to any prior art in this description is not, and should not be taken as, an acknowledgement or any form of suggestion that such prior art forms parts of the common general knowledge in any art in any country. Along these lines, any recognition of problems in the prior art discussed in this Background section or associated with such subject matter should not be treated as prior art, unless expressly stated to be prior art. Rather, the discussion of any subject matter in this Background section should be treated as part of the approach taken towards the particular problem by one or more inventors. This approach in and of itself may also be inventive.

### BRIEF DESCRIPTION OF THE DRAWINGS

FIG. 1 is a schematic illustration of a system arranged in accordance with examples described herein.

FIG. 2 is a schematic illustration including example digital resource rules arranged in accordance with examples described herein.

FIG. 3 is a schematic illustration of a system arranged in accordance with examples described herein.

FIG. 4 is a flowchart illustrating an example method arranged in accordance with examples described herein.

FIG. 5 is a schematic illustration of a computer system arranged in accordance with examples described herein.

FIG. 6 is a schematic illustration of a system arranged in accordance with examples described herein.

FIG. 7 is a flowchart illustrating an example method arranged in accordance with examples described herein.

FIG. 8 is a schematic illustration of a user interface arranged in accordance with examples described herein.

FIG. 9 is a schematic illustration of an example flow diagram arranged in accordance with examples described herein.

### DETAILED DESCRIPTION

Certain details are set forth herein to provide an understanding of described embodiments of technology. However, other examples may be practiced without various ones of these particular details. In some instances, well-known computing system components, virtualization components, circuits, control signals, timing protocols, and/or software operations have not been shown in detail in order to avoid unnecessarily obscuring the described embodiments. Other embodiments may be utilized, and other changes may be made, without departing from the spirit or scope of the subject matter presented herein. The various embodiments disclosed herein are not necessarily mutually exclusive, as some disclosed embodiments can be combined with one or more other disclosed embodiments to form new embodiments.

Examples described herein include computer systems, storage media (including non-transitory computer-readable storage media) that may store programs, and methods. Providing, in a timely and efficient manner, accurate and reliable information regarding transactions that may be used to calculate further resource obligations presents a technical problem for software systems that may be designed to identify and calculate resource obligations based on, and in accordance with, one or more resource obligation rules.

For example, the increasing frequency at which existing resource obligation rules change and new resource obligation rules are introduced, coupled with existent, numerous, unique regulations across many different jurisdictions, creates an environment in which accurate resource obligation calculation and collection, as well as accurate and timely reporting, becomes increasingly challenging. A business generally cannot keep up with tax laws and differentiate different types of taxes and respective filing needs. Inaccurate resource obligation calculation, collection, and/or reporting may each individually, as well as together in combination, result in negative and costly consequences, and may even be unlawful.

In some traditional systems, a user (and/or a business and/or an entity) may have the option to inform an online software platform of new filing requirements manually. In some traditional systems, the online software platform may obtain the new filing requirements by researching and informing a customer (e.g., user, business, entity, etc.). However, these traditional systems are not computationally efficient, are timely and costly, and are not easily technically scalable. Furthermore, such traditional systems may place a burden on both the customer and the online software platform’s computer resources. Moreover, such traditional systems are also prone to miss the timely manner of resource obligation calculation and reporting compliance.

As such, systems and methods described herein provide compliance and reporting benefits, including automatically recognizing and calculating new resource obligations based on new resource obligation rules, as well as automatically assisting with resource obligation reporting needs. In some examples, systems and methods described herein may calculate a new type of tax. In some examples, systems and methods described herein may determine a new reporting/filing need based on, for example, the new type of tax. In some examples, systems and methods described herein may automatically report and/or file the new type of tax.

Advantages of systems and methods described herein include, but are not limited to, enhancing an online software platform’s existing resource obligation determination (e.g., tax calculation) and output data (e.g., tax return filing, tax return, forms, form filings, fee forms, etc.) platforms. Additional benefits of systems and methods described herein may include alleviating the burden of interaction between a customer (e.g., a user, business, entity, etc.) and the online software platform to, in some examples, remind, permit, and file a new liability type. As such, and advantageously, systems and methods described herein may auto-recognize the need of a new returns filing (e.g., a new field, new amount, new form(s), new return, new tax rate, new fee, new tax liability, new return altogether, etc.) based on a new liability created from transaction data. Systems and methods described herein may then additionally, if required, auto-register the user (e.g., business, entity, etc.) to file this new liability. In some examples, systems and methods described herein may perform one or more of these operations via one or more authorizations (e.g., pre-consent) from the user (e.g., business, entity, etc.).

Accordingly, examples of systems and methods described herein may receive transaction data for an entity at an online software platform. The online software platform may calculate resource obligations associated with the transaction data. The online software platform may further compare the resource obligations with historical resource obligations incurred by the entity. For example, historical resource obligations incurred by the entity may be stored in storage accessible to the online software platform. The online software platform may, based on the comparison, search for authorization to prepare data output. The comparison may indicate that at least one of the resource obligations is a new resource obligation for the entity. Once authorization is obtained and/or accessed, the online software platform may prepare the data output for the new resource obligation.

In some examples, the storage accessible to the online software platform may comprise historical resource obligations incurred by one or more entities, including the entity. In some examples, the storage may further comprise authorizations for at least one of the one or more entities, including the entity. In some examples, the storage accessible to the online software platform may comprise one or more resource obligations, including, in some examples, the resource obligations associated with the transaction data.

In some examples, the resource obligation may be associated with an existing resource obligation rule (e.g., an existing tax rule, an existing liability rule, an existing tax rate, an existing fee rate, an existing tax liability, etc.). In some examples, the resource obligations associated with the transaction data may comprise a tax liability, a fee liability, or combinations thereof. In some examples, each of the existing resource obligation rule and the new resource obligation rule comprises a tax liability rate, a fee liability rate, or a combination thereof.

In some examples, upon receipt (and/or detection and/or identification) of a new resource obligation rule, the online software platform may store the new resource obligation rule for utilization in the calculation, determination, and or collection of resource obligations (e.g., during a transaction). For example, the online software platform may receive a new resource obligation rule associated with the resource obligation. In some examples, the online software platform may compare the new resource obligation rule with the existing obligation rule. The online software platform may, in some examples, and based on a determination that the new resource obligation rule is different from the existing resource obligation rule, replace the existing resource obligation rule with the new resource obligation rule. In some examples, the online software platform may store the new resource obligation rule in storage, such as in the storage accessible to the online software platform. In some examples, the new resource obligation may be based at least in part on the new resource obligation rule.

In some examples, the online software platform may, responsive to storing the received one or more authorizations in storage accessible to it based on the authorization alert, determine that one or more of the new resource obligation rule requires registration. In some examples, such registration may include registration with a domain(s) for at least one of the one or more entities. In some examples, the online software platform may register at least one of the one or more entities with the domain upon receipt, identification, and/or accessing of the authorization(s). In some examples, the domain may comprise a government entity. In some examples, the domain may be jurisdiction-specific. In some examples, the domain may correspond to a county, parish, municipality, state, federal, and/or other governmental level jurisdiction.

In some examples, upon receipt (and/or detection and/or identification) of a new resource obligation rule, the online software platform may generate an authorization alert for a user (and/or a business and/or an entity). For example, the online software platform may receive a new resource obligation rule associated with a resource obligation. The online software platform may, in some examples, determine that the new resource obligation rule is different from an existing resource obligation rule associated with the resource obligation. Upon determining that the new resource obligation rule is different from the existing resource obligation rule associated with the resource obligation, the online software platform may generate an authorization alert. The authorization alert may be used by the online software platform to obtain authorization from the user (and/or business and/or entity) to prepare one or more data outputs based on the new resource obligation rule associated with the resource obligation.

In some examples, the online software platform may receive, via the authorization alert (e.g., an authorization alert completed by a user, business, and/or entity), one or more authorizations from one or more entities to prepare the one or more data outputs. Such outputs may be based on the new resource obligation rule associated with the resource obligation detected and/or identified by the online software platform and/or received at the online software platform. In some examples, the online software platform may store the one or more authorizations in storage, such as in storage accessible to the online software platform.

In some examples, once authorization is obtained and/or accessed, the online software platform may prepare the data output for the new resource obligation. In some examples, the data output for the new resource obligation may be a tax return. In some examples, the output data from a new resource obligation may be one or more forms, including one or more tax return forms. In some examples, the data output for a new resource obligation may be the completion of a new line item on an existing form, existing return, and the like. In some examples, the data output for the new resource obligation may be both a new return and/or new form, as well as the completion of a new line item and/or existing line item on an existing form. In some examples, the online software platform may, responsive to preparing the data output for the new resource obligation, transmit (e.g., file, submit, upload etc.) the data output (e.g., tax form, tax filing, tax return) for the new resource obligation (corresponding to the transaction data) to the domain (e.g., a government entity).

In one non-limiting example, Colorado State (e.g., a jurisdiction) may impose a Retail Delivery Fee (e.g., a resource obligation) in addition to sales tax (e.g., another resource obligation) for any orders delivered within Colorado State. In traditional systems, the online software platform may allow for the calculation of the Retail Delivery Fee using a configuration. The online software platform’s customer (e.g., user, business, entity) may also file returns with the online software platform. These returns may exclusively relate to already-existing regular sales tax returns. However, the collection of this new Retail Delivery Fee may necessitate that customers report and file this new Retail Delivery Fee separately, which in turn may require the customer to manually inform the online software platform to file this new liability related to the new Retail Delivery Fee.

Advantageously, systems and methods described herein automatically recognize the need to file a new tax collection (e.g., the new liability related to the new Retail Delivery Fee) separately from the existing sales tax. In some examples, the filing of the new tax obligation may be using an existing form. In some examples, the filing of the new tax obligation may be using a new form altogether. In some examples, the filing of the new tax obligation may occur due to obtaining a customer’s (e.g., user, business, entity, etc.) authorization (e.g., pre-consent).

As should be understood, systems and methods described herein are applicable to many different types of resource obligations and/or obligation rules, such as taxes and fees. Another non-limiting example of a resource obligation is Washington State’s requirement to collect bag fees. In some examples, the new resource rule (e.g., Colorado State’s new Retail Delivery Fee) may not necessitate filing a new return. In some examples, the new resource rule (e.g., Colorado State’s new Retail Delivery Fee) may only require the need to fill in a new field and/or line item on an existing return (e.g., output date). In some examples, the new resource rule (e.g., Colorado State’s new Retail Delivery Fee) may require both the filing of a new return and the need to fill in a new field and/or line item on an existing return.

In this manner, systems and methods described herein provide compliance and reporting benefits, including automatically recognizing and calculating new resource obligations based on new resource obligation rules, as well as automatically assisting with resource obligation reporting needs.

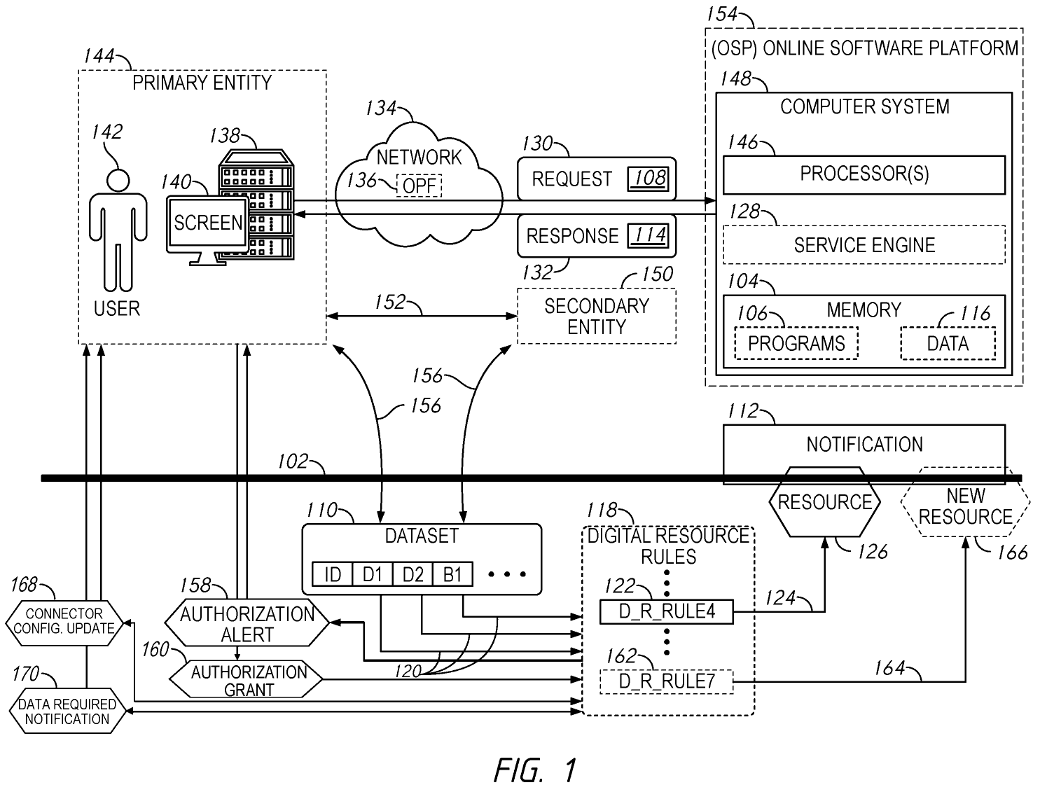

FIG. 1 is a schematic illustration of a system arranged in accordance with examples described herein. A thick horizontal line 102 separates this diagram, although not completely or rigorously, into a top portion and a bottom portion. Above the line 102 are shown elements with emphasis mostly on entities and components, and their relationships and their interactions, while below the line 102 are shown elements with emphasis mostly on processing of data that takes place often within one or more of the components that are above the line 102.

Above the line 102, a sample computer system 148 according to embodiments is shown. The computer system 148 has one or more processors 146 and a memory 104. The memory 104 stores programs 106 and data 116. The one or more processors 146 and the memory 104 of the computer system 148 thus implement a service engine 128.

The computer system 148 can be located in “the cloud.” In fact, the computer system 148 may optionally be implemented as part of an Online Software Platform (OSP) 154. The OSP 154 can be configured to perform one or more predefined services, for example, via operations of the service engine 128. Such services can be searches, determinations, computations, verifications, notifications, the transmission of specialized information, including data that effectuate payments, the generation and transmission of documents, the online accessing of other systems to effect registrations, and so on, including what is described herein. Such services can be provided in the form of Software as a Service (SaaS). As such, the OSP 154 can be an online software provider.

A user 142 may be standalone. The user 142 may use a computer system 138 that has a screen 140, on which user interfaces (UIs) may be shown. In embodiments, the user 142 and the computer system 138 are considered part of a primary entity 144. In such instances, the user 142 can be an agent of the primary entity 144, and even within a physical site of the primary entity 144, although that is not necessary. In embodiments, the computer system 138 or other device of the user 142 can be client devices for the computer system 148. The user 142 or the primary entity 144 can be clients for the OSP 154. For instance, the user 142 may log into the computer system 148 by using credentials, such as a username, a password, a token, and so on. Generally, in examples described herein, the primary entity 144 may be an enterprise (e.g., a corporation which may be selling goods or services, a business, etc.).

The computer system 138 may access the computer system 148 via a communication network 134, such as the Internet. In particular, the entities and associated systems of FIG. 1 may communicate via physical and logical channels of the communication network 134. For example, information may be communicated as data using the Internet Protocol (IP) suite over a packet-switched network such as the Internet or other packet-switched network, which may be included as part of the communication network 134. The communication network 134 may include many different types of computer networks and communication media, including those used by various different physical and logical channels of communication, now known or later developed. Non-limiting media and communication channel examples include one or more, or any operable combination, of: fiber optic systems, satellite systems, cable systems, microwave systems, Asynchronous Transfer Mode (ATM) systems, frame relay systems, Digital Subscriber Line (DSL) systems, Radio Frequency (RF) systems, telephone systems, cellular systems, other wireless systems, and the Internet. In various embodiments the communication network 134 can be or include any type of network, such as a Local Area Network (LAN), a Metropolitan Area Network (MAN), a Wide Area Network (WAN), or the Internet. Accordingly, from certain perspectives, the OSP 154 is in the cloud and is therefore depicted in FIG. 1 within the communication network 134.

Accessing, downloading, and/or uploading and so on may be permitted among these computer systems. Such can be performed, for instance, with manually uploading files, like spreadsheet files, etc. Such can also be performed automatically as shown in the example of FIG. 1, with systems exchanging requests and responses.

Moreover, in some embodiments, data from the computer system 138 and/or from the computer system 148 may be stored in an Online Processing Facility (OPF) 136 that can run software applications, perform operations, and so on. In such embodiments, requests and responses may be exchanged with the OPF 136, downloading or uploading may involve the OPF 136, and so on. In such embodiments, the computer system 138 and any devices of the OPF 136 can be considered to be remote devices, at least from the perspective of the computer system 148.

In some instances, the user 142 and/or the primary entity 144 have instances of relationships with secondary entities. Only one such secondary entity 150 is shown. In this example, the primary entity 144 has a relationship instance 152 with the secondary entity 150.

In some instances, the user 142 and/or the primary entity 144 obtain data about one or more secondary entities, for example, as necessary for conducting the relationship instances with them. The primary entity 144 and/or the secondary entity 150 may be referred to as simply entities. One of these entities may have one or more attributes. Such an attribute of such an entity may be any one of its name, type of entity, a physical or geographical location such as an address, a contact information element, an affiliation, a characterization of another entity, a characterization by another entity, an association or relationship with another entity (general or specific instances), an asset of the entity, a declaration by or on behalf of the entity, a specific domain that the entity belongs to in a context of multiple domains that are defined in terms of the above, and so on.

In some examples, a secondary entity 150 may be a customer. The customer may be another computer system in some examples or may be an individual consumer. Customers may interact with the primary entity 144 by buying and/or consuming goods or services. One or more customers may engage in transactions with the primary entity 144. A transaction may generally refer to an exchange of goods and/or services. The computer system 138 may collect and/or store transaction data relating to one or more transactions.

In embodiments, the computer system 148 receives one or more datasets. A sample received dataset 110 is shown below the line 102. The dataset 110 may be received by the computer system 148 in a number of ways. In some embodiments, one or more requests may be received by the computer system 148 via a network. In this example, a request 130 is received by the computer system 148 via the communication network 134. The request 130 has been transmitted by the remote computer system 138. The received one or more requests can carry payloads. In this example, the request 130 carries a payload 108. In such embodiments, the one or more payloads may be parsed by the computer system 148 to extract the dataset 110. In this example, the payload 108 can be parsed by the computer system 148 to extract the dataset 110. In this example the single payload 108 encodes the entire dataset 110, but that is not required. In fact, a dataset can be received from the payloads of multiple requests. In such cases, a single payload may encode only a portion of the dataset. And, of course, the payload of a single request may encode multiple datasets. Additional computers may be involved with the communication network 134, some beyond the control of the user 142 or OSP 154, and some within such control.

The dataset 110 has values that can also be called dataset values. The dataset values can be numerical, alphanumeric, Boolean, and so on, as needed for what the values characterize. For example, an identity value ID may indicate an identity of the dataset 110, so as to differentiate it from other such datasets. At least one of the dataset values may characterize an attribute of a certain one of the entities 144 and 150, as indicated by corresponding arrows 156. For instance, a value D1 may be the name of the certain entity, a value D2 may be for relevant data of the entity, and so on. Plus, an optional value B1 may be a numerical base value. The database value B1 can be for an aspect of the dataset, and so on. The aspect of the dataset may be the aspect of a value that characterizes the attribute, an aspect of the reason that the dataset was created in the first place, and so on. The dataset 110 may further have additional dataset values, as indicated by the horizontal dot-dot-dot in the right side of the dataset 110. (Each time, the dot-dot-dot suggests possibly more of what it follows.) In some embodiments, the dataset 110 has values that characterize attributes of both the primary entity 144 and the secondary entity 150, but that is not required. In some examples, the dataset 110 includes values that characterize one or more transactions. The dataset 110 may accordingly include data relating to one or more transactions. Data relating to transactions may include, but is not limited to, identification of seller, identification of buyer, product identification, service identification, price, term, and/or date.

In embodiments, digital resource rules 118 are provided for use by the OSP 154. In the example of this diagram, two sample digital resource rules are shown explicitly, namely rule D_R_RULE4 122 and rule D_R_RULE7 162. The rule D_R_RULE4 122 may be an existing resource obligation rule and the rule D_R_RULE7 162 may be a newly received, identified, and/or detected resource obligation rule. All other such rules within the digital resource rules 118 are indicated by the vertical dot-dot-dots. These digital resource rules 118 are digital in that they are implemented for use by software. For example, these digital resource rules 118 may be implemented within the programs 106 and data 116. The data portion of these digital resource rules 118 may alternately be stored in memories that are local or in other places that can be accessed by the computer system 148. The storing can be in the form of a spreadsheet, a database, etc.

In embodiments, the computer system 148 may access the stored digital resource rules 118. This accessing may be performed responsive to the computer system 148 receiving a dataset, such as the dataset 110.

Then the computer system 148 may select a certain one of the accessed digital resource rules 118. In some examples, rule D_R_RULE4 122 may be selected as the certain digital resource rule. The selection of this particular rule is indicated also by the fact that an arrow 124 begins from that rule.

The computer system 148 may thus select the rule D_R_RULE4 122 responsive to one or more of the dataset values of the dataset 110. The impact of the dataset 110 in the selection may be indicated by at least some of arrows 120.

Then the computer system 148 may produce a resource for the dataset 110, such as resource 126. The computer system 148 may thus produce the resource 126 by applying the rule D_R_RULE4 122, which was previously selected, to at least one of the dataset values of the dataset 110. In the example of FIG. 1, the resource 126 is produced for the dataset 110 by the computer system 148 applying the rule D_R_RULE4 122, as indicated by the arrow 124. The impact of the dataset 110 in producing the resource 126 is indicated by at least one of the arrows 120.

In embodiments, the computer system 148 may select other certain one(s) of the accessed digital resource rules 118. In some examples, the rule D_R_RULE7 162 may be selected as the certain digital resource rule. In some examples, the rule D_R_RULE7 162 may be selected as a new resource obligation rule to replace the rule D_R_RULE4 122 as the existing (e.g., historical, old, outdated, resource obligation rule) rule. The selection of this particular rule is indicated also by the fact that an arrow 164 begins from that rule.

The computer system 148 may thus select the rule D_R_RULE7 162 responsive to one or more of the dataset values of the dataset 110. The impact of the dataset 110 in the selection may be indicated by at least some of the arrows 120.

In embodiments, the computer system 148 may select other certain one(s) of the accessed digital resource rules 118, such as the rule D_R_RULE7 162, based further on determining and/or obtaining and/or accessing an authorization, such as an authorization from the user 142 and/or the primary entity 144.

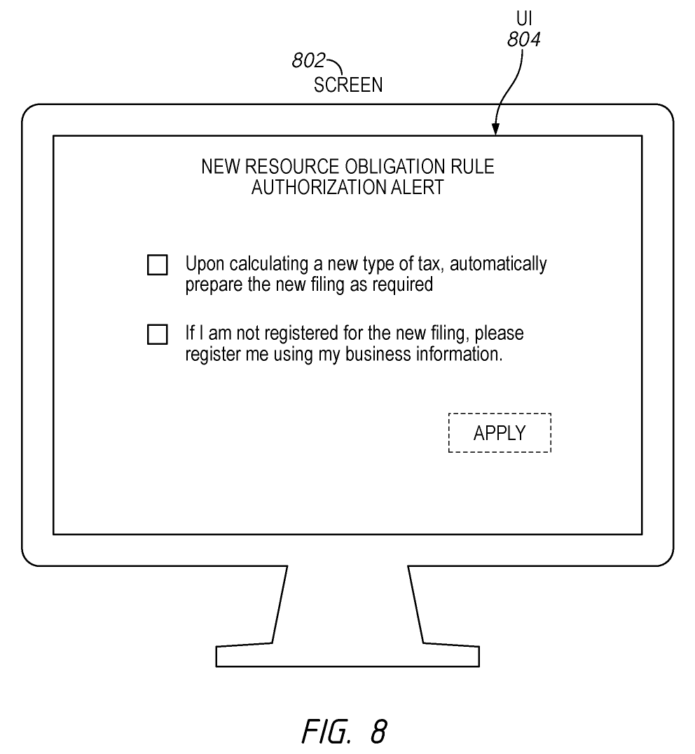

In embodiments, upon detection, identification, and/or receipt of the rule D_R_RULE7 162 in the digital resource rules 118, the OSP 154 may transmit an authorization alert, such as an authorization alert 158 (such as the authorization alert depicted in user interface 804 on screen 802 of FIG. 8), to the user 142. The user 142 may make selections (e.g., via one or more interactive methods, including buttons, touch regions, spoken word, etc.) authorizing one, both, or none of (1) upon calculating a new resource obligation based on a new resource obligation rule, preparing a new data output as required, and (2) if user is not registered for the data output, registering the user using the user’s business information.

In embodiments, upon receipt of an authorization grant, such as an authorization grant 160, the computer system 148 may select the rule D_R_RULE7 162.

Then the computer system 148 may produce a new resource for the dataset 110, such as a new resource 166. The computer system 148 may thus produce the new resource 166 by applying the rule D_R_RULE7 162, which was previously selected, to at least one of the dataset values of the dataset 110. In the example of FIG. 1, the new resource 166 is produced for the dataset 110 by the computer system 148 applying the rule D_R_RULE7 162, as indicated by the arrow 164. The impact of the dataset 110 in producing the new resource 166 is indicated by at least one of the arrows 120.

The produced resource and/or new resource can be a document, a determination, a computational result, etc., made, created, or prepared for the user 142, and/or the primary entity 144, and/or the secondary entity 150, etc. As such, in some embodiments, the resource and/or new resource is produced by processing and/or a computation. In some embodiments, therefore, the resource and/or new resource is produced on the basis of a characterized attribute of the primary entity 144 and/or the secondary entity 150. In some examples, the resource and/or new resource is produced on the basis of transaction data.

The resource and/or new resource may be produced in a number of ways. For instance, at least one of the dataset values of the dataset 110 can be a numerical base value, e.g., B1, as mentioned above. In such cases, applying the certain digital resource rule may include performing a mathematical operation on the base value B1. For example, applying the certain digital resource rule may include multiplying the numerical base value B1 with a number indicated by the certain digital resource rule. Such a number can be, for example, a percentage, e.g., 1.5%, 3%, 5%, and so on. Such a number can be indicated directly by the certain digital resource rule, or be stored in a place indicated by the certain digital resource rule or by the dataset 110, and so on.

In some embodiments two or more digital main rules may be applied to produce the resource and/or the new resource. For example, the computer system 148 may select, responsive to one or more of the dataset values, another one of the accessed digital resource rules 118. These one or more dataset values can be the same as, or different than, the one or more dataset values responsive to which the first selected rule was selected. In such embodiments, the resource can be produced by the computer system 148 also applying the other selected digital resource rule to at least one of the dataset values. For instance, where the base value B1 is used, applying the first selected rule may include multiplying the numerical base value B1 with a first number indicated by the first selected rule, so as to compute a first product. In addition, applying the second selected rule may include multiplying the numerical base value B1 with a second number indicated by the second selected rule, so as to compute a second product. In addition, a value of the resource may be produced by summing the first product and the second product.

In embodiments, a notification can be caused to be transmitted, e.g., via the communication network 134, by the computer system 148. In the example of FIG. 1, a notification 112 can be caused to be transmitted by the computer system 148, for example, as an answer or other response to the received dataset 110.

The notification 112 may be about an aspect of the resource and/or the new resource, and possibly not about the whole resource and/or the whole new resource; or the notification 112 can be about the whole resource and/or the whole new resource. For example, the notification 112 may inform about an aspect of the resource 126, namely that it has been determined, or where it can be found, or what it is, or a portion of its content, or a value of it, or a statistic of the value, or a rounded version of the value, and so on. Of course, the planning should be such that the recipient of the notification 112 understands what it is being provided. In some examples, the notification 112 may inform about an aspect of the new resource 166, namely that it has been determined, or where it can be found, or what it is, or a portion of its content, or a value of it, or a statistic of the value, or a rounded version of the value, and so on. The notification 112 can be about the authorization alert 158, in some examples. The notification 112 can be about the authorization grant 160 in some examples.

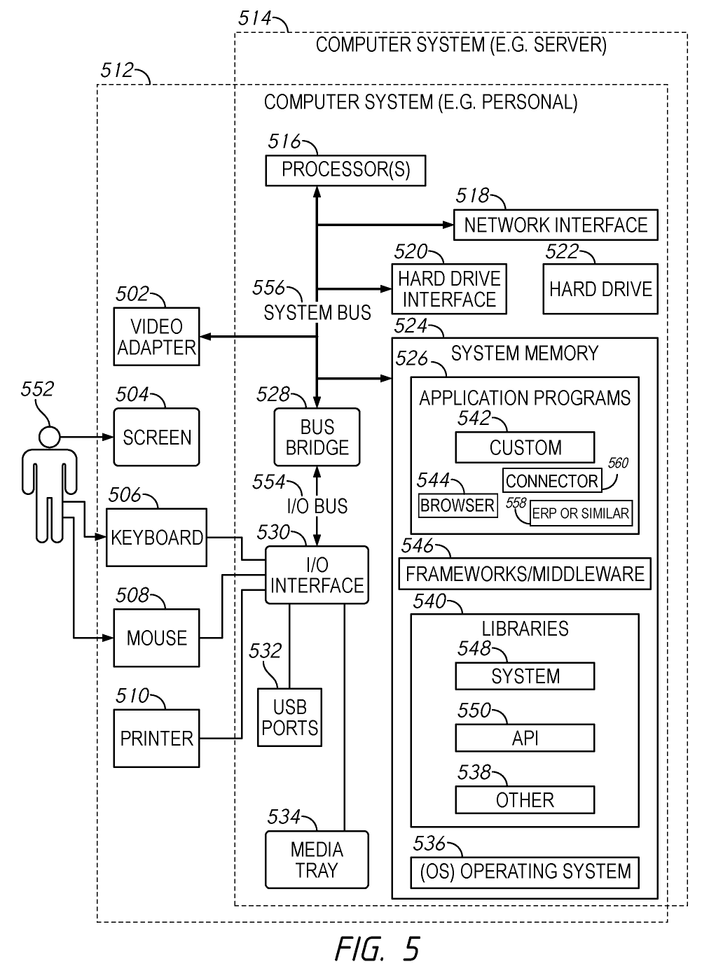

The notification 112 can be transmitted to one of an output device and another device. The output device may be the screen of a local user or a remote user (such as screen 140 of FIG. 1, screen 504 of FIG. 5, and/or screen 802 of FIG. 8, etc.). The notification 112 may thus cause a desired image, message, or other such notification to appear on the screen, such as within a Graphical User Interface (GUI) and so on. The other device can be the remote device, from which the dataset 110 was received, as in the example of FIG. 1. In particular, the computer system 148 may cause the notification 112 to be communicated by being encoded as a payload 114, which is carried by a response 132. The response 132 may be transmitted via the communication network 134 responsive to the received request 130. The response 132 may be transmitted to the computer system 138, or to the OPF 136, and so on. As such, the other device can be the computer system 138, or the OPF 136, or the screen 140 of the user 142, and so on. In this example, the single payload 114 encodes the entire notification 112, but that is not required. Similarly, with what is written above about encoding datasets in payloads, the notification 112 instead may be provided via two or more payloads, or in other cases, the notification 112 and at least one other notification may be included in the same single payload 114. Along with the aspect of the resource 126 and/or the new resource 166, it can be advantageous to embed in the payload 114 the identity value ID and/or one or more values of the dataset 110. This will help the recipient correlate the response 132 to the request 130 and therefore match the received aspect of the resource 126 and/or the new resource 166 as the answer or other response to the appropriate dataset 110.

As seen above, the computer system 138, the computer system 148, and possibly also the OPF 136 may exchange requests and responses. Such can be implemented with a number of different architectures. Two examples are now described with reference to the computer systems 138 and 148 only.

In one such architecture, a device remote to the service engine 128, such as the computer system 138, may have a certain application (not shown) and a connector (not shown) that may be implemented as a plugin that sits on top of that certain application. The connector may be able to fetch from the remote device the details used for the service desired from the OSP 154, form an object or payload (e.g., 108), and then send or push a request (e.g., 130) that carries the payload to the service engine 128 via a service call. The service engine 128 may receive the request with its payload. The service engine 128 may then access the digital resource rules 118, find the appropriate one(s) of them, and apply it or them to the payload to produce the requested resource 126 and/or the requested new resource 166. The service engine 128 may then form a payload (e.g., 114) that includes an aspect of the resource 126 and/or the new resource 166, and then push, send, or otherwise cause to be transmitted a response (e.g., 132) that carries the payload it formed to the connector. The connector receives the response, reads its payload, and forwards that payload to the certain application.

An alternative such architecture uses Representational State Transfer (REST) Application Programming Interfaces (APIs). REST or RESTful API design is designed to take advantage of existing protocols. While REST can be used over nearly any protocol, it usually takes advantage of Hyper Text Transfer Protocol (HTTP) when used for Web APIs. In such an alternative architecture, a device remote to the service engine 128, such as the computer system 138, may have a particular application (not shown). In addition, the computer system 148 implements a REST API (not shown). This alternative architecture enables the primary entity 144 to directly consume a REST API from their particular application, without using a connector. The particular application of the remote device may be able to fetch internally from the remote device the details used for the service desired from the OSP 154 and thus send or push the request 130 to the REST API. In turn, the REST API talks in the background to the service engine 128. Again, the service engine 128 determines the requested resource 126 and/or the new resource 166 and sends an aspect of it back to the REST API. In turn, the REST API sends the response 132 that has the payload 114 to the particular application.

Referring again to the digital resource rules 118, digital rules in embodiments can be expressed in the form of a logical “if-then” statement, such as: “if P then Q.” In such statements, the “if” part, represented by the “P,” is called the condition, and the “then” part, represented by the “Q,” is called the consequent. In a set of digital rules, the condition or the consequent may be repeated. For instance, the condition can be the same for multiple different rules. And the consequent can be the same for multiple different rules.

Searching for a rule that applies can be performed by searching for whether the rule’s one or more conditions are met. The computer system may recognize that such a condition is met. For instance, the certain condition could define a boundary of a region that is within a space. The region could be geometric and be within a larger space. The region could be geographic, within the space of a city, a state, a country, a continent, or the earth. The boundary of the region could be defined in terms of numbers according to a coordinate system within the space. In the example of geography, the boundary could be defined in terms of groups of longitude and latitude coordinates. For instance, the attribute could be a location of the entity, and the one or more values of the dataset 110 that characterize the location could be one or more numbers, or an address, or longitude and latitude. A condition can be met depending on how the one or more values compare with the boundary. For example, the comparison may reveal that the location is in the region instead of outside the region. The comparison can be made by rendering the characterized attribute in units comparable to those of the boundary. For example, the characterized attribute could be an address that is rendered into longitude and latitude coordinates, and so on.

In some examples, the certain condition could be an attribute of a transaction – a particular product, attribute of a product, location of the transaction, identity of the seller or buyer, etc. A condition can be met depending on how the transaction data compare with predetermined transaction data for particular digital rules.

The search can be iterative through all the digital rules of a set of rules or of a subset of rules. Sometimes once the condition of one rule is met, its consequent is applied, and the search effectively stops. Other times, all eligible rules are searched, and those whose conditions are met are marked for later consideration and application, for instance by proper implementation of the consequent.

The digital resource rules 118 include the rule D_R_RULE4 122 and rule D_R_RULE7 162 that are eventually selected and applied (e.g., the rule D_R_RULE4 122 may be selected and applied and the rule D_R_RULE7 162 may be selected and applied, and/or the rule D_R_RULE7 162 may be selected and applied as a new rule/replacement for the rule D_R_RULE4 122). In some embodiments, the digital resource rules 118 are implemented by simple rules. A simple rule has a single condition (“P”), and a single consequent (“Q”). In some examples, as a result of an initial search, then, the rule D_R_RULE4 122 may be selected, and then its consequent may be applied to produce the resource 126. In some examples, as a result of an initial search, then, the rule D_R_RULE7 162 may be selected, and then its consequent may be applied to produce the new resource 166.

In some embodiments, the digital resource rules 118 further include additional digital resource rules that select that digital resource rule, the rule D_R_RULE4 122 and/or D_R_RULE7 162 in the first place, for ultimately applying it. In such embodiments, the digital resource rules 118 can be implemented as simple rules or as complex rules. Complex rules may have more than one condition and/or more than one consequent. Complex rules may be implemented as individual single rules with complex coding. Alternatively, a complex rule may be implemented in part by more than one simple individual rule, which can have hierarchical relationships among them, e.g., from one rule’s application or execution leading to another, and so on. As a result of the initial search, then, rules are found which, when applied, select that certain rule in the first place.

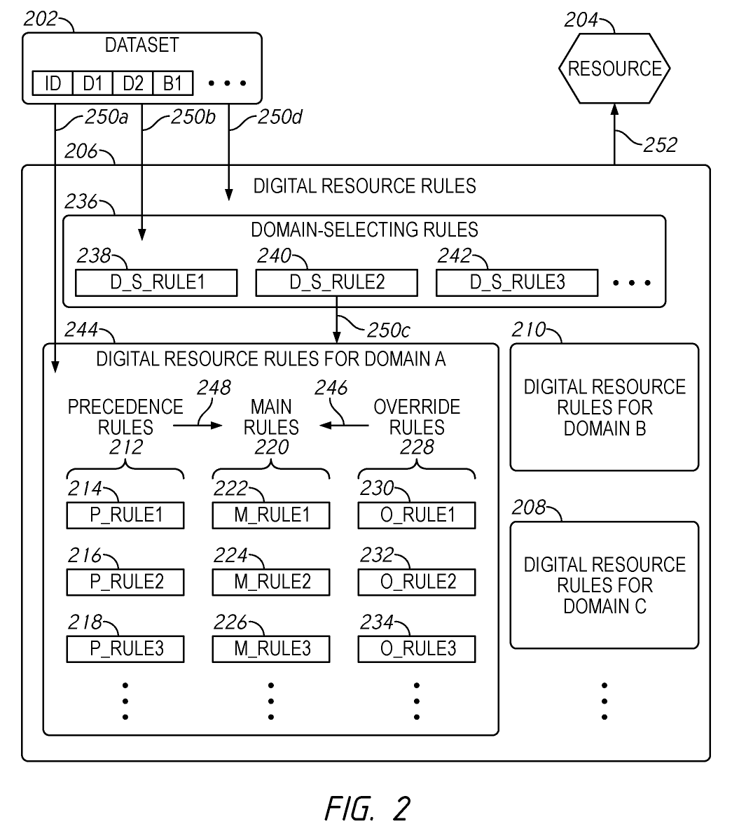

FIG. 2 is a schematic illustration including example digital resource rules arranged in accordance with examples described herein. Referring now to FIG. 2, a dataset 202 can be as described for the dataset 110 of FIG. 1. In addition, a set 206 of digital resource rules is an example of digital resource rules, such as the digital resource rules 118 of FIG. 1.

Similarly with FIG. 1, in FIG. 2 a resource 204 can be produced according to an arrow 252. The resource 204 can be as the resource 126 of FIG. 1, at least an aspect of which can be reported by the notification 112 of FIG. 1, and so on.

The set 206 of digital resource rules includes different subsets, into which the individual rules belong. In addition, there are hierarchical relationships among rules of different subsets, and/or of types. One of these individual rules is eventually selected and applied, while one or more of them may have been used for selecting it. That certain rule that is eventually selected is not pointed out in FIG. 2, as it was pointed out in FIG. 1, so as to not suggest that that certain rule necessarily belongs in any one of the subsets. In fact, that certain rule can be in any one of the subsets of the digital resource rules 206.

In the example of FIG. 2, the set 206 includes a subset 236 of domain-selecting rules. The set 206 also includes subsets 244, 210, 208, …, each for digital resource rules for domains A, B, C, … respectively. A domain for which a subset of resource rules is thus provided could be associated with the primary entity 144 of FIG. 1, another domain could be associated with the secondary entity 150 of FIG. 1, and so on.

In many embodiments, one of the domain-selecting rules of the subset 236 can be used to select which domain’s rules should be applied. Then the certain one of the digital resource rule(s) can be selected from the digital resource rules of the selected domain. Then the resource 204 can be produced by applying the selected certain digital resource rule(s) to at least one of the dataset values of the dataset 202.

In this example, the subset 236 of domain-selecting rules includes rules D_S_RULE1 238, D_S_RULE2 240, D_S_RULE3 242, and further rules as indicated by the ellipsis in FIG. 2. One of these rules may be selected and used when more than one domain could be considered as eligible for its rules to apply. The rules of the subset 236, however, might not be necessary for embodiments where a single domain is considered or implied for one or more, or all, of the relationship instances. This can happen, for example, when it is known in advance that the primary entity 144 and every possible secondary entity are both associated with the same domain; or when it is planned that digital resource rules of only one domain will be considered, while any rules of any other domain will not be considered and will be disregarded.

Examples of resource rules for individual domains are now described. Such rules need not be the same for each domain or of the same type for each domain. The sample subset 244 of resource rules for domain A is now described in more detail. Its description can be similar for subsets for other domains, such as the subsets 210, 208, and further subsets as indicated by the ellipsis in FIG. 2.

The subset 244 of resource rules includes different types of rules. In this example, the subset 244 includes precedence rules 212, main rules 220, and override rules 228. In this example, the precedence rules 212 include rules P_RULE1 214, P_RULE2 216, P_RULE3 218, and others as indicated by the ellipsis in FIG. 2. The main rules 220 include rules M_RULE1 222, M_RULE2 224, M_RULE3 226, and others as indicated by the ellipsis in FIG. 2. The override rules 228 include rules O_RULE1 230, O_RULE2 232, O_RULE3 234, and others as indicated by the ellipsis in FIG. 2.

In embodiments, one of the main rules 220 may ordinarily be selected as the certain digital resource rule, which in FIG. 1 is shown as the rule D_R_RULE4 122. In other words, the certain digital resource rule could be, say, the main rule M_RULE2 224.

In this example, although not always required, the different types of rules within the subset 244 further have different hierarchies among them.

For a first instance, one of the precedence rules 212 may indicate which one of the main rules 220 is to be selected, as generally indicated by an arrow 248. Or one of the precedence rules 212 that does apply may itself be the eventually selected certain digital resource rule, instead of indicating any one of the main rules 220.

For a second instance, even when one of the main rules 220 is thus indicated, one of the override rules 228 may still override the indication, as generally indicated by an arrow 246. In such cases, the one of the rules 228 that overrides may be the eventually selected certain digital resource rule, instead of one of the main rules 220. Or one of the rules 228 may override by indicating yet a different one of the main rules 220 to be selected instead, and so on.

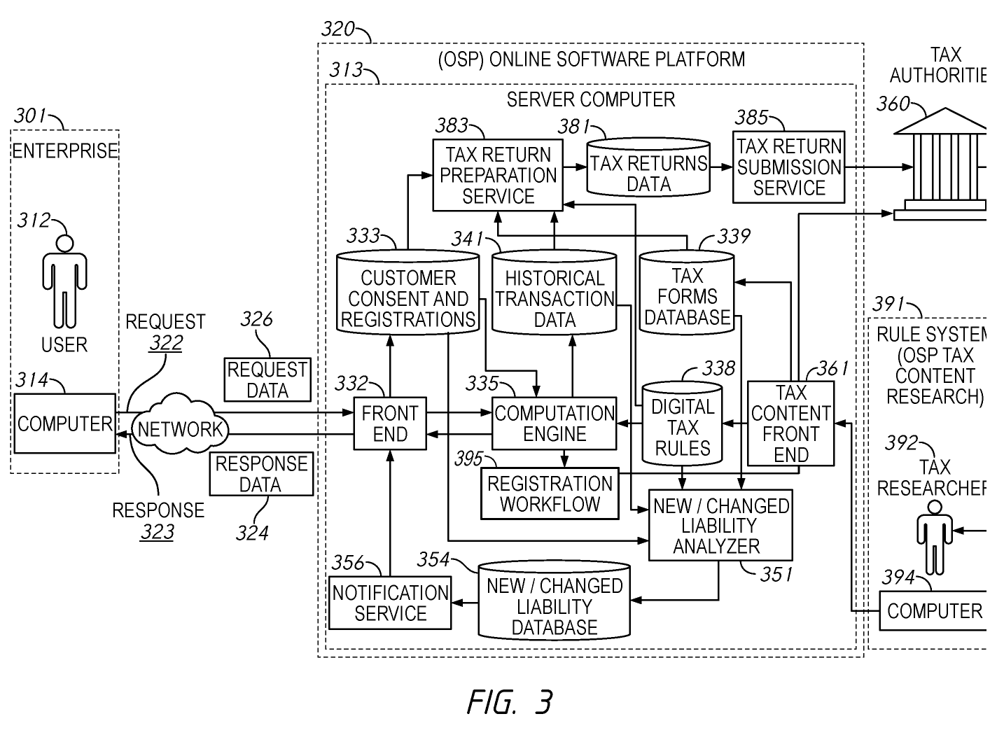

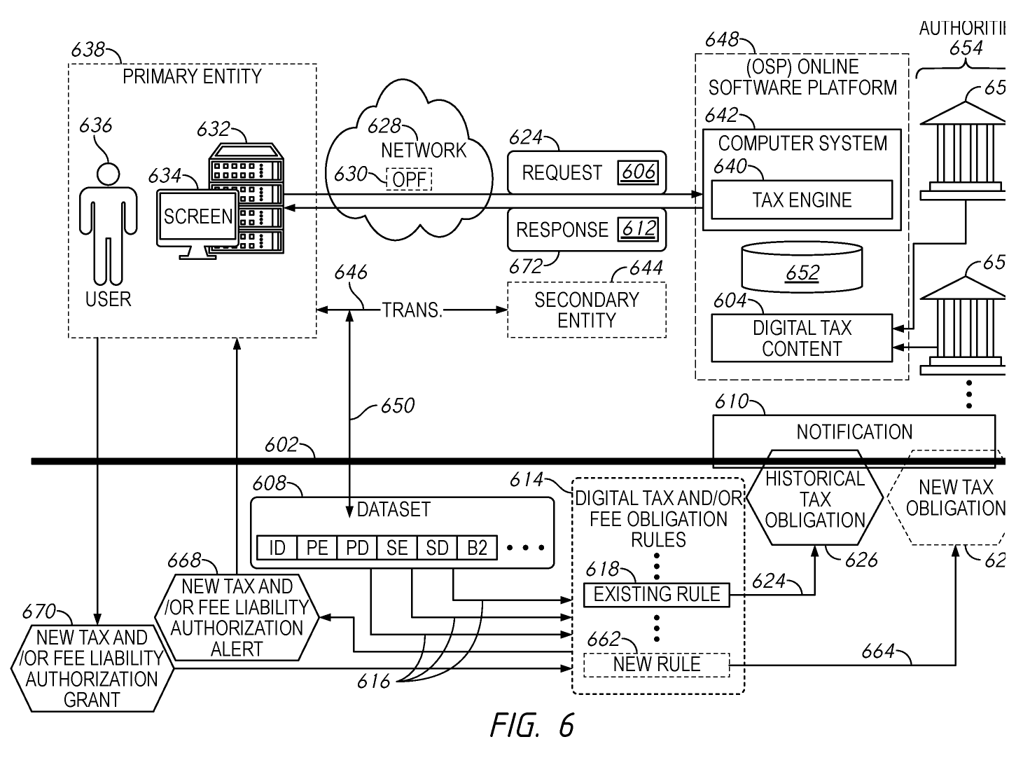

In some examples, the rule M_RULE1 222 may correspond to an existing and/or historical resource obligation rule for a transaction, a user, and/or an entity. An online software platform such as the OSP 154 of FIG. 1, OSP 320 of FIG. 3, and/or OSP 648 of FIG. 6 may receive, detect, and/or identify a new resource obligation rule. Such new resource obligation rule may, in some examples, correspond to an override rule, such as the rule O_RULE1 230. In some examples, upon detection of a new resource obligation rule, such as the O_RULE1 230, an online software platform, such as the OSP 154 of FIG. 1, OSP 320 of FIG. 3, and/or OSP 648 of FIG. 6, may calculate a resource obligation associated with the new resource obligation rule. In some examples, after calculating the resource obligation, an online software platform such as the OSP 154 of FIG. 1, OSP 320 of FIG. 3, and/or OSP 648 of FIG. 6 may search for an authorization to prepare data output using the calculated new resource obligation. In some examples, an online software platform such as the OSP 154 of FIG. 1, OSP 320 of FIG. 3, and/or OSP 648 of FIG. 6 may prepare the data output for the new resource obligation. In some examples, the rule M_RULE1 222 may correspond to the rule D_RULE4 122 of FIG. 1 and/or existing rule 618 of FIG. 6. In some examples, the rule O_RULE1 230 may correspond to the rule D_RULE7 162 of FIG. 1 and/or new rule 662 of FIG. 6.

In FIG. 2, sample arrows 250a, 250b, 250c, and 250d begin from the dataset 202. These arrows suggest possible paths of the eventual selection of the certain rule for ultimately producing the resource 204. These arrows are more detailed versions of the arrows 120 of FIG. 1. They are examples of possible arrows, and not all of them are necessarily used in every such determination.

According to the arrow 250a, the subset 244 is indicated. So, at least one of the rules of the subset 244 may initially be indicated as the certain rule, e.g., from one or more values of the dataset 202. The initially indicated rule can be the finally certain rule or another intermediate rule which, in turn, will be used to select that certain rule.

According to the arrow 250b, at least one of the domain-selecting rules of the subset 236 may be invoked, from one or more values of the dataset 202.

According to the arrow 250c, one of the rules of subset 236 that was invoked by the arrow 250b was the rule D_S_RULE2 240. And the arrow 250c further indicates that the invoked rule points to the subset 244, instead of to the subsets 210, 208, or others as indicated by the ellipsis in FIG. 2. As such, the subset 244 of resource rules should be used for selecting the certain rule. This example has the same result, but from a different path, as the sample arrow 250a.

The arrow 250d is drawn to indicate that one or more of the values of the dataset 202 are received and processed by the finally selected certain rule for producing the resource 204.

FIG. 3 is a schematic illustration of a system arranged in accordance with examples described herein.

The example of FIG. 3 includes enterprise 301, OSP 320, and rule system (OSP tax content research) 391.

The enterprise 301 may operate computer 314, in some examples, by way of user 312. The user 312 may be a customer of the enterprise 301.

The OSP 320 may include server computer 313. The server computer 313 may include front end 332, computation engine 335, new/changed liability analyzer 351, notification service 356, tax content front end 361, tax return preparation service 383, and tax return submission service 385. The server computer 313 may include and/or be in communication with one or more storage containers and/or data repositories, such as customer consent and registrations 333, digital tax rules 338, tax forms database 339, historical transaction data 341, new/changed liability database 354, and tax returns data 381.

The rule system 391 may include computer 394. The rule system 391 may operate the computer 394, in some examples, by way of tax researcher 392. The rule system 391 may be in communication with authorities, such as tax authority 360. During operation, the enterprise 301 may send to the OSP 320 and/or server computer 313 a request 322 which may include request data 326 via a network (e.g., the Internet, etc.). The enterprise 301 may receive a response 323 including response data 324 via a network (e.g., the Internet, etc.).

FIG. 3 may in some examples be used to implement and/or may be implemented by the system of FIG. 1. For example, the OSP 320 may be used to implement and/or may be implemented by the OSP 154 of FIG. 1. The enterprise 301 may be used to implement and/or may be implemented by the primary entity 144 of FIG. 1. The user 312 may be used to implement and/or may be implemented by the secondary entity 150 of FIG. 1.

The components shown in FIG. 3 are exemplary. Additional, fewer, and/or different components may be present in other examples.

Examples of systems described herein accordingly may interact with one or more enterprise systems, such as the enterprise 301 of FIG. 3. The enterprise 301 may generally be a corporation, business, or other organization which is engaging in transactions (e.g., selling goods and/or services). The enterprise 301 may maintain one or more computer systems, such as the computer 314 of FIG. 3. Computers operated by enterprises interacting with the online software platforms described herein may be referred to as client systems. Accordingly, the computer 314 may be referred to as client systems in some examples. The computer systems of the enterprise 301 may include one or more processors and computer-readable media (e.g., memory or other electronic storage) (e.g., non-transitory computer-readable media, non-transitory computer-readable storage media storing instructions) which may be encoded with executable instructions for performing operations described herein. For example, computer systems of the enterprise 301 may be implemented using the computer 314. Generally, computer systems of the enterprise 301 may include one or more software applications that may manage and/or integrate business processes and/or process transactions, and/or collect transaction data.

Examples of systems described herein may include one or more rule systems, such as the rule system (OSP tax content research) 391 of FIG. 3. The rule system 391 may be implemented using one or more computer systems, such as the computer 394 of FIG. 3. The computer 394 of FIG. 3 may include one or more processors and computer-readable media (e.g., non-transitory computer-readable storage media) encoded with executable instructions for performing operations described herein. The rule system 391 may be in communication with one or more authorities or other entities, such as the tax authority 360 of FIG. 3.

In some examples, the tax authority 360 may be, for example, a governmental entity, such as a federal government, state government, local government, and/or other entity which may set rules for resource obligations, such as tax or fee obligations relating to transactions. The tax authority 360 may itself have one or more computer systems. Accordingly, the computer 394 may communicate with one or more computer systems of various authorities to develop digital rules described herein, such as digital resource rules 118 of FIG. 1 and/or digital resource rules 206 of FIG. 2, and the like. In some examples, an expert or other user of the rule system 391 may synthesize, format, store, or otherwise arrange the digital resource rules for use by the OSP 320.

Examples of systems described herein may include online software platforms, such as the OSP 320 of FIG. 3. While examples may be implemented using an online software platform, other examples may not utilize an online software platform. Examples of systems described herein, including examples using online software platforms, may include one or more computing systems, such as the server computer 313. The server computer 313 may include one or more processors and computer-readable media (e.g., memory or other electronic storage) (e.g., non-transitory computer-readable storage media storing executable instructions) encoded with instructions which, when executed by the processor, cause the computer to perform operations described herein. Any number of processors and computer-readable media may be present. The computer-readable media may be integral to and/or in communication with the server computer 313.

Examples of OSPs and/or computers described herein may include a front end, such as the front end 332. The front end 332 may be implemented using one or more processors (such as one or more processors of the server computer 313) and (non-transitory) computer-readable media encoded with instructions for performing liability analysis operations described herein.

Examples of OSPs and/or computers described herein may include a tax content front end, such as the tax content front end 361. The tax content front end 361 may be implemented using one or more processors (such as one or more processors of the server computer 313) and (non-transitory) computer-readable media encoded with instructions for performing liability analysis operations described herein.

Examples of OSPs and/or computers described herein may include a new/changed liability analyzer, such as the new/changed liability analyzer 351. The new/changed liability analyzer 351 may be implemented using one or more processors (such as one or more processors of the server computer 313) and (non-transitory) computer-readable media encoded with instructions for performing liability analysis operations described herein.

Examples of OSPs and/or computers described herein may include a computation engine, such as the computation engine 335. The computation engine 335 may be implemented using one or more processors (such as one or more processors of the server computer 313) and (non-transitory) computer-readable media encoded with instructions for performing liability analysis operations described herein.

Examples of OSPs and/or computers described herein may include a tax return preparation service, such as the tax return preparation service 383. The tax return preparation service 383 may be implemented using one or more processors (such as one or more processors of the server computer 313) and (non-transitory) computer-readable media encoded with instructions for performing liability analysis operations described herein.

Examples of OSPs and/or computers described herein may include a tax return submission service, such as the tax return submission service 385. The tax return submission service 385 may be implemented using one or more processors (such as one or more processors of the server computer 313) and (non-transitory) computer-readable media encoded with instructions for performing liability analysis operations described herein.

In some examples, the OSP 320, via the front end 332, may generally be configured to receive transaction data from an entity, such as transaction data over a network from the user 312 of the enterprise 301 by way of the computer 314. In some examples, the transaction data may comprise information for the calculation(s) of tax liabilities. In some examples, the transaction data may comprise information for the calculation(s) of a sales tax. In some examples, the transaction data may comprise information for the calculation(s) of fee liabilities.

In some examples, the OSP 320, via the computation engine 335, may generally be configured to calculate a resource obligation associated with the transaction data. In some examples, the resource obligation may be associated with a resource obligation rule stored in storage, such as the digital tax rules 338. In some examples, the resource obligation may be associated with an existing resource obligation rule (e.g., an existing tax rule, an existing liability rule, an existing tax rate, an existing fee rate, an existing tax liability, etc.) stored in storage, such as the digital tax rules 338. In some examples, the resource obligations associated with the transaction data may comprise a tax liability, a fee liability, or combinations thereof. In some examples, each of the existing resource obligation rule and the new resource obligation rule comprises a tax liability rate, a fee liability rate, or a combination thereof.

In some examples, the OSP 320, via the tax content front end 361, may generally be configured to receive one or more new digital resource rules (e.g., resource obligation rules) for use by the OSP 320. In some examples, the tax content front end 361 may generally be configured to receive the one or more digital resource rules from the rule system 391, and in some examples, by way of the tax authority 360. In some examples, the one or more digital resource rules that the tax content front end 361 may receive from the rule system 391 may include one or more new digital resource rules. In some examples, the one or more digital resource rules that the tax content front end 361 may receive from the rule system 391 may include one or more new resource obligation rules. In some examples, the one or more digital resource rules the tax content front end 361 may receive from the rule system 391 may include one or more new tax/fee obligation rules. In some examples, the tax content front end 361 may store the one or more digital resource rules in storage, such as the digital tax rules 338.

In some examples, upon receipt (and/or detection and/or identification) of a new resource obligation rule at the tax content front end 361, the new/changed liability analyzer 351 may analyze the new resource obligation rule. In some examples, upon determining that the new resource obligation rule replaces an existing resource obligation rule or is an entirely new resource obligation rule, the new/changed liability analyzer 351 may store the new resource obligation rule in storage, such as at the new/changed liability database 354. In some examples, the new resource obligation rule may be stored at the new/changed liability database 354 for utilization in the calculation, determination, and or collection of resource obligations (e.g., during a transaction). In some examples, the new resource obligation may be based at least in part on the new resource obligation rule stored, in some examples, at the new/changed liability database 354.

For example, the OSP 320 may receive a new resource obligation rule at the tax content front end 361 associated with an existing resource obligation. In some examples, the online software platform via the new/changed liability analyzer 351 may compare the new resource obligation rule with the existing resource obligation rule. The online software platform via the new/changed liability analyzer 351 may, in some examples, and based on a determination that the new resource obligation rule is different from the existing resource obligation rule, replace the existing resource obligation rule with the new resource obligation rule. In some examples, the online software platform via the new/changed liability analyzer 351 may store the new resource obligation rule in storage, such as at the new/changed liability database 354. As should be appreciated, while the new resource obligation rule is described as being stored at the new/changed liability database 354 by the new/changed liability analyzer 351, new resource obligation rules (as well as additional and/or alternative resource obligation rules and/or additional and/or alternative new resource obligation rules) may be stored at the new/changed liability database 354 and/or other storage locations, such as, in some examples, other storage locations of FIG. 3.

In some examples, upon receipt (and/or detection and/or identification) of a new resource obligation rule at the tax content front end 361, the online software platform via the notification service 356 may be configured to generate an authorization alert for a user (and/or a business and/or an entity), such as the user 312 using the computer 314 of the enterprise 301. For example, the online software platform at the tax content front end 361 may receive a new resource obligation rule associated with a resource obligation. The online software platform may via the new/changed liability analyzer 351, in some examples, determine that the new resource obligation rule is different from an existing resource obligation rule associated with the resource obligation. Upon determining that the new resource obligation rule is different from the existing resource obligation rule associated with the resource obligation via the new/changed liability analyzer 351, the online software platform may via the notification service 356 generate an authorization alert. The authorization alert may be used by the OSP 320 to obtain authorization from the user 312 (and/or business and/or entity) to prepare one or more data outputs based on the new resource obligation rule associated with the resource obligation.

In some examples, the online software platform may receive, via the notification service 356 and/or at the front end 332, and via the authorization alert (e.g., an authorization alert completed by a user, business, and/or entity), one or more authorizations from one or more entities to prepare the one or more data outputs. Such outputs may be based on the new resource obligation rule associated with the resource obligation detected and/or identified by the online software platform and/or received at the online software platform. In some examples, the online software platform may store the one or more authorizations in storage, such as the customer consent and registrations 333.

In some examples, the online software platform, via the notification service 356, may be configured to, responsive to storing the received one or more authorizations in storage accessible to it based on the authorization alert, determine that one or more of the new resource obligation rule requires registration. In some examples, such registration may include registration with one or more domain(s) for at least one of the one or more entities. In some examples, the online software platform may register, via the notification service 356, at least one of the one or more entities with the domain upon receipt, identification, and/or accessing of the authorization(s). In some examples, the domain may comprise a local, state, and/or federal government entity. In some examples, the domain may be jurisdiction-specific. In some examples, the online software platform, via the notification service 356, may be configured to store the returned authorization grants (e.g., pre-consent(s), etc.) in one or more storage repositories, including the customer consent and registrations 333. In some examples, the online software platform, via the notification service 356, may be configured to store the registrations of the entity based on the authorization grant, in one or more storage repositories, including the customer consent and registrations 333.

In some examples, the OSP 320, via the new/changed liability analyzer 351, may generally be configured to compare the resource obligations with historical resource obligations incurred by the entity and stored in storage accessible to the online software platform, such as the historical transaction data 341. In some examples, the storage accessible to the online software platform, such as the historical transaction data 341, may comprise historical resource obligations incurred by one or more entities.

In some examples, the OSP 320, via the notification service 356, may generally be configured to search for authorization to prepare data output. In some examples, the notification service 356 may be configured to search for the authorization based on the comparison by the new/changed liability analyzer 351 indicating that at least one of the resource obligations is a new resource obligation. In some examples, the notification service 356 may be configured to search storage, such as the customer consent and registrations 333. In some examples, the customer consent and registrations 333 may comprise one or more authorizations for one or more entities. In some examples, the customer consent and registrations 333 may comprise completed pre-consent forms, such as, in some examples, completed new resource obligation rule authorization alerts such as the new resource obligation authorization alert illustrated in FIG. 8.

In some examples, the OSP 320, via the tax return preparation service 383, may generally be configured to prepare the data output for the new resource obligation. In some examples, the data output prepared by the tax return preparation service 383 may be stored in storage, such as the tax returns data 381, prior to filing, transmitting, and/or uploading by the tax return submission service 385. In some examples, once authorization is obtained and/or accessed, the online software platform may, via the tax return preparation service 383, prepare the data output for the new resource obligation. In some examples, the data output for the new resource obligation stored at the tax returns data 381 is a tax return. In some examples, the online software platform may, via the tax return submission service 385, responsive to preparing the data output for the new resource obligation via the tax return preparation service 383, transmit (e.g., file, submit, upload etc.) the data output (e.g., tax form, tax filing, tax return) for the new resource obligation (corresponding to the transaction data) to the domain (e.g., a government entity).

As a non-limiting example, the OSP 320 may be configured to receive a pre-consent authorization from the user 312 at the front end 332. The pre-consent authorization may be indicative of the user 312 opting (e.g., authorizing) the OSP 320 to automatically handle any new resource rule obligation filings. In this example, the OSP 320 may be configured to, while calculating one or more tax and/or fee liabilities on a transaction, flag the transaction if a new type of tax and/or fee liability is calculated and/or determined. Here, the OSP 320 may then compare one or more (or all) transactions and their respective tax type liability with the customer’s returns setup in the OSP 320’s returns filing platform. Here, when (and/or if) the OSP 320 finds a gap, it programmatically looks up the filing laws mandated by the tax authority (e.g., the tax authority 360) for this new type of tax. Here, the OSP 320 may, in some examples, either adjust the current return filing form to account for this new liability or, in some examples, prepare an altogether new return and keep it ready for review and filing by user. In some examples, additionally and/or alternatively, the OSP 320 may be configured to check the need of registering the customer for filing this new liability with the tax authority. If, in some examples, the OSP 320 finds that a customer needs to register with a tax authority, then, in some examples, the OSP 320 may be configured to register the customer for this new tax liability based on a pre-consent from customer.

In some examples, permissions from a customer (e.g., the user 312 using the computer 314 of the enterprise 301) to perform one or more of the operations described herein, including automatically calculating new resource obligations and/or preparing and filing output data, are required. In some examples, additionally and/or alternatively, if the new resource obligation rule(s) necessitates registration with a tax authority, then, in some examples, a user may also need to grant the OSP 320 permission to perform the registration with the tax authority on their behalf. In some examples, such permission may additionally and/or alternatively include digital signature-based authorization.

In some examples, when the OSP 320 is calculating the taxes on a transaction, the OSP 320 may be configured to look up its proprietary database of tax laws (e.g., the digital tax rules 338) which may be kept updated in real time and/or near real time. Here, the OSP 320 may be configured to apply all (and/or one or more) of the tax laws applicable to the transaction. In some examples, the OSP 320 may be configured to calculate the tax liabilities. The OSP 320 may be further configured to compare all (and/or one or more) of the resulting tax types (in some examples, the OSP 320 calls a specific tax a tax type) and then compare all the tax types with all the taxes customer is setup to file with the OSP 320. In some examples, upon finding a mismatch, the OSP 320 may learn that there is a new type of tax liability being generated by the customer’s transactions for which they are not set up to file a return. Here, in some examples, this event may trigger the automatic calculation and/or reporting of the new resource obligation, including user registration, as described herein.

In some examples, the ultimate output (e.g., output data) generated from the OSP 320 via the tax return preparation service 383 comprises a new return, or a new liability reported on an existing return form, or both. In some examples, the OSP 320 may generate one or more internal notifications during the process of finding new tax types and/or gaps between filing arrangements. In some examples, both the tax authority and customer may be notified upon a determination that a new registration is needed.

In this way, systems and methods described herein include the OSP 320 comparing transaction data with tax laws and determining one or more (or all) taxes to calculate. Systems and methods described herein further include OSP 320 comparing the calculated taxes with customer’s returns set up. Systems and methods described herein further include OSP 320 determining if a new filing is required. In some examples, sources used to collect data and prepare output data (e.g., a tax return) include but are not limited to internal sources, such as a customer’s tax profile data with the OSP 320 and transaction data, and external sources, such as a tax authority’s websites and other resources such as a filing Application Programming Interface (API). Systems and methods described herein further include, in some examples, determining if a new liability (e.g., new resource obligation rule) necessitates a new registration for customer. In some examples, by using already stored tax profile data and/or permissions from customer, the OSP 320 is configured to register the customer with the tax authorities for reporting the new liability. In some examples, to complete the return (e.g., data output), the OSP 320 is configured to complete the return using its existing returns filing methods. In some examples, to file the return (e.g., tax return), the OSP 320 may be configured to file the return using its existing returns filing methods.

In some examples, the OSP 320 may be configured to generate reports for new tax liability.

In some examples, the OSP 320 may be configured to allow for a user to set notification preferences in settings. In some examples, such settings may allow for a user to be notified when the OSP 320 prepares a new filing for customer and registers the customer for a new liability.

In some examples, the OSP 320 may be configured to store a customer’s business and tax profile.

In some examples, the OSP 320 may be configured to register a customer with a tax authority for a new type of liability reporting using customer’s business profile data and permissions to do so.

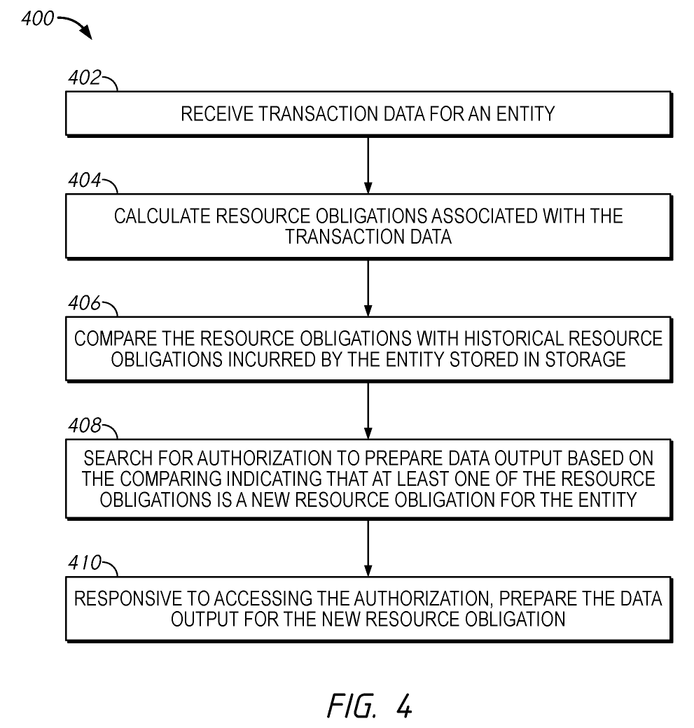

FIG. 4 is a flowchart illustrating an example method 400 arranged in accordance with examples described herein.

The method 400 includes receiving transaction data for an entity in block 402, calculating resource obligations associated with the transaction data in block 404, comparing the resource obligations with historical resource obligations incurred by the entity stored in storage in block 406, searching for authorization to prepare data output based on the comparing indicating that at least one of the resource obligations is a new resource obligation for the entity in block 408, and, responsive to accessing the authorization, preparing the data output for the new resource obligation in block 410.

Block 402 recites receiving transaction data for an entity. In some examples, the transaction data for the entity may be received by the front end 332 of the OSP 320 of FIG. 3. In some examples, the transaction data may be received from the computer 314 of the enterprise 301 of FIG. 3. In some examples, the transaction data may be received from the user 312 using the computer 314 of the enterprise 301 of FIG. 3. In some examples, the transaction may be transmitted over a network, such as one or more networks described herein. In some examples, the transaction data may be received by one or more other components, such as one or more additional and/or alternative components of FIG. 3.

Block 404 recites calculating resource obligations associated with the transaction data. In some examples, one or more components of the OSP 320 of FIG. 3 may calculate the resource obligations associated with the transaction data. For example, in some examples, the computation engine 335 of FIG. 3 may be configured to calculate the resource obligations associated with the transaction data. In some examples, the computation engine 335 of FIG. 3 may calculate the resource obligations associated with the transaction data using one or more rules, such as resource obligation rules. In some examples, the computation engine 335 of FIG. 3 may calculate the resource obligations associated with the transaction data using the digital tax rules 338 of FIG. 3. In some examples, the computation engine 335 of FIG. 3 may calculate the resource obligations associated with the transaction data using information and/or data and/or metadata stored in other storage locations of FIG. 3, such as, for example, the historical transaction data 341 and/or the new/changed liability database 354 of FIG. 3.

In some examples, the digital resource rules (e.g., resource obligation rules, new resource obligation rules, fee rules, tax rules, etc.) may be received by the OSP 320 at the tax content front end 361. In some examples, the tax content front end 361 may receive the digital resource rules by one or more entities and/or authorities, such as the tax authorities 360 of FIG. 3 and/or the rule system 391 and/or the tax researcher 392 by way of the computer 394 of FIG. 3.

Block 406 recites comparing the resource obligations with historical resource obligations incurred by the entity stored in storage. In some examples, one or more component of FIG. 3 may be configured to compare the resource obligations with historical resource obligations incurred by the entity stored in storage. For example, the computation engine 335 may be configured to compare the resource obligations with historical resource obligations incurred by the entity. In some examples, the historical resource obligations that the computation engine 335 compares may be stored in one or more locations of, for example, FIG. 3. In some examples, the historical resource obligations that the computation engine 335 compares may be stored in the historical transaction data 341.

Block 408 recites searching for authorization to prepare data output based on the comparing indicating that at least one of the resource obligations is a new resource obligation for the entity. In some examples, one or more components of an OSP system, such as the OSP 320 of FIG. 3, may be configured to search for authorization to prepare data output. In some examples, the notification service 356 may be configured to search for authorization to prepare data output. In some examples, the notification service 356 may be configured to transmit an authorization alert to a user/entity/business/customer (such as the alert of FIG. 8), receive a completed authorization grant in response to the authorization alert, and/or store the authorization grant in storage, such as the customer consent and registrations 333. In some examples, the notification service 356 may be configured to register the user/entity/business/customer based on receipt of the completed authorization grant. In some examples, the notification service 356 may be configured to register the user/entity/business/customer with an entity (e.g., a government authority) such as the tax authorities 360 of FIG. 3.

In some examples, the tax return preparation service 383 may be configured to search for the authorization grant (e.g., pre-consent, pre-consent authorization, etc.) stored in the customer consent and registrations 333. In some examples, the tax return preparation service 383 may be configured to search for user/entity/business/customer registration in the customer consent and registrations 333. In some examples, the notification service 356 may receive a completed authorization grant in response to the authorization alert, at the front end 332.

Block 410 recites responsive to accessing the authorization, preparing the data output for the new resource obligation. In some examples, responsive to accessing the authorization information in, for example, the customer consent and registrations 333, the tax return preparation service 383 may be configured to prepare the data output for the new resource obligation. In some examples, the data output for the new resource obligation may comprise the completion of a new form, such as a new tax form. In some examples, the data output for the new resource obligation may comprise the completion of a new line item on one or more existing form(s). In some examples, the data output for the new resource obligation may comprise updating one or more old line item(s) on one or more existing form(s). In some examples, the tax return preparation service 383 may store the data output in one or more storage locations, such as those illustrated in the OSP 320 of FIG. 3. For example, the tax return preparation service 383 may store the data output in the tax returns data 381.

In some examples, the tax return submission service 385 may file/upload/submit the data output. In some examples, the tax return submission service 385 may file/upload/submit the data output to one or more entities, such as with the tax authorities 360. In some examples, the tax return submission service 385 may file/upload/submit the data output to one or more entities, such as one or more local, state, federal, etc. governmental entities and/or agencies and/or departments.

In examples, the storage accessible to the online software platform may comprise historical resource obligations incurred by one or more entities, including the entity. In some examples, historical resource obligations incurred by one or more entities may be stored at the historical transaction data 341. In some examples, the storage may further comprise authorizations for at least one of the one or more entities, including the entity. In some examples, authorizations for at least one of the one or more entities may be stored at the customer consent and registrations 333. In some examples, the storage accessible to the online software platform may comprise one or more resource obligations, including, in some examples, the resource obligations associated with the transaction data. In some examples, one or more resource obligations, including, in some examples, the resource obligations associated with the transaction data may be stored at the digital tax rules 338 and/or the historical transaction data 341 and/or the tax forms database 339 and/or the new/changed liability database 354, among others. In examples, the resource obligation may be associated with an existing resource obligation rule.

In examples, upon receipt of a new resource obligation rule, such as at the tax content front end 361, the online software platform, such as the OSP 320, may store the new resource obligation rule for utilization in the calculation, determination, and or collection of resource obligations (e.g., during a transaction), such as at the digital tax rules 338 and/or the new/changed liability database 354, among other storage locations. For example, the OSP 320 may receive a new resource obligation rule associated with the resource obligation at tax content front end 361. In some examples, the OSP 320, via the new/changed liability analyzer 351, may compare the new resource obligation rule with the existing obligation rule, and, based on a determination that the new resource obligation rule is different from the existing resource obligation rule, replace the existing resource obligation rule with the new resource obligation rule. In some examples, the new resource obligation may be based, at least in part, on the new resource obligation rule. In some examples, the new resource obligation rule may be stored at the new/changed liability database 354. In some examples, the new resource obligation rule may be stored at the digital tax rules 338. In some examples, the new resource obligation rule may be stored at one or more other storage locations.

In examples, an online software platform, such as the OSP 320 of FIG. 3, may determine that one or more of the new resource obligation rules requires registration. In some examples, the notification service 356 of FIG. 3 may be configured to determine that one or more of the new resource obligation rules requires registration. In some examples, such registration may include registration with a domain(s) for at least one of the one or more entities. In some examples, the online software platform may register at least one of the one or more entities with the domain upon receipt, identification, and/or accessing of the authorization(s). In some examples, the tax return preparation service 383 may be configured to register at least one of the one or more entities with the domain. In some examples, the computation engine 335 may be configured to register at least one of the one or more entities with the domain. In some examples, the notification service 356 may be configured to register at least one of the one or more entities with the domain. In some examples, one or more components, such as but not limited to the tax return preparation service 383, the computation engine 335, and/or the notification service 356, may be configured to store confirmation of the registration. In some examples, the confirmation of the registration may be stored in the customer consent and registrations 333.

In examples, upon receipt of a new resource obligation rule, an online software platform, such as the notification service 356 of the OSP 320 of FIG. 3, may generate and/or transmit an authorization alert for a user (and/or a business and/or an entity), such as the authorization/consent/pre-consent alert of FIG. 8. In some examples, the online software platform may receive, via the completed authorization (e.g., a completed authorization and/or consent grant by a user, business, and/or entity), one or more authorizations from one or more entities to prepare the one or more data outputs. In some examples, the completed authorization grant may be received at the OSP 320 by the front end 332. In some examples, the completed authorization grant may be stored in the customer consent and registrations 333. In some examples, once authorization is obtained and/or accessed, the OSP 320, via in some examples the tax return preparation service 383, may prepare the data output for the new resource obligation.

In this way, systems and methods described herein provide compliance and reporting benefits, including automatically recognizing and calculating new resource obligations based on new resource obligation rules, as well as automatically assisting with the resource obligation reporting needs.

FIG. 5 is a schematic illustration of a computer system arranged in accordance with examples described herein. FIG. 5 includes a sample computer system 514 and a sample computer system 512. The computer system 514 may be a server, while the computer system 512 may be a personal device, such as a personal computer, a desktop computer, a personal computing device such as a laptop computer, a tablet computer, a mobile phone, and so on. Either type may be used for the computer system 148 and computer system 138 of FIG. 1, and/or a computer system that is part of the OPF 136.

Further, either the computer system 514 and/or the computer system 512 may be used to implement the server computer 313, computer 314, and/or computer 394 of FIG. 3.

The computer system 514 and the computer system 512 have similarities, which FIG. 5 exploits for purposes of economy in this document. It will be understood, however, that a component in the computer system 514 may be implemented differently than the same component in the computer system 512. For instance, a memory in a server may be larger than a memory in a personal computer, and so on. Similarly, custom application programs 542 that implement embodiments may be different, and so on.

The computer system 514 includes one or more processor(s) 516. The processor(s) 516 are one or more physical circuits that manipulate physical quantities representing data values. The manipulation can be according to control signals, which can be known as commands, op codes, machine code, etc. The manipulation can produce corresponding output signals that are applied to operate a machine. As such, one or more processor(s) 516 may, for example, include a Central Processing Unit (CPU), a Reduced Instruction Set Computing (RISC) processor, a Complex Instruction Set Computing (CISC) processor, a Graphics Processing Unit (GPU), a Digital Signal Processor (DSP), a Field-Programmable Gate Array (FPGA), an Application Specific Integrated Circuit (ASIC), any combination of these, and so on. A processor may further be a multi-core processor having two or more independent processors that execute instructions. Such independent processors are sometimes called “cores.”

A hardware component such as a processor may also include programmable logic or circuitry that is temporarily configured by software to perform certain operations. For example, a hardware component may include software executed by a general-purpose processor or another type of programmable processor. Once configured by such software, hardware components become specific machines, or specific components of a machine, uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations.

As used herein, a “component” may refer to a device, physical entity or logic having boundaries defined by function or subroutine calls, branch points, Application Programming Interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. The hardware components depicted in the computer system 514, or the computer system 512, are not intended to be exhaustive. Rather, they are representative, for highlighting essential components that can be used with embodiments.

The computer system 514 also includes a system bus 556 that is coupled to the processor(s) 516. The system bus 556 can be used by the processor(s) 516 to control and/or communicate with other components of the computer system 514.

The computer system 514 additionally includes a network interface 518 that is coupled to the system bus 556. The network interface 518 can be used to access a communications network, such as the communication network 134 of FIG. 1. The network interface 518 can be implemented by a hardware network interface, such as a Network Interface Card (NIC), wireless communication components, cellular communication components, Near Field Communication (NFC) components, Bluetooth® components such as Bluetooth® Low Energy, Wi-Fi® components, etc. Of course, such a hardware network interface may have its own software, and so on.

The computer system 514 also includes various memory components. These memory components include memory components shown separately in the computer system 514, plus cache memory within the processor(s) 516. Accordingly, these memory components are examples of non-transitory machine-readable media. The memory components shown separately in the computer system 514 are variously coupled, directly or indirectly, with the processor(s) 516. The coupling in this example is via the system bus 556.

Instructions for performing any of the methods or functions described in this document may be stored, completely or partially, within the memory components of the computer system 514, etc. Therefore, one or more of these non-transitory computer-readable media can be configured to store instructions which, when executed by one or more processor(s) 516 of a host computer system such as the computer system 514 or the computer system 512, can be designed to or programmed to cause the host computer system to perform operations according to embodiments. The instructions may be implemented by computer program code for carrying out operations for aspects of this document. The computer program code may be written in any combination of one or more programming languages, including an object-oriented programming language such as Java, Smalltalk, or the like, and/or conventional procedural programming languages, such as the “C” programming language or similar programming languages such as C++, C Sharp, etc.

The memory components of the computer system 514 include a non-volatile hard drive 522. The computer system 514 further includes a hard drive interface 520 that is coupled to the hard drive 522 and to the system bus 556.

The memory components of the computer system 514 include a system memory 524. The system memory 524 includes volatile memory including, but not limited to, cache memory, registers, and buffers. In embodiments, data from the hard drive 522 populates registers of the volatile memory of the system memory 524.

In some embodiments, the system memory 524 has a software architecture that uses a stack of layers, with each layer providing a particular functionality. In this example the layers include, starting from the bottom, an (OS) Operating System 536, libraries 540, frameworks/middleware 546, and application programs 526, which are also known more simply as applications 526. Other software architectures may include less, more, or different layers. For example, a presentation layer may also be included. For another example, some mobile or special purpose operating systems may not provide a frameworks/middleware 546.

The (OS) Operating System 536 may manage hardware resources and provide common services. The libraries 540 provide a common infrastructure that is used by the applications 526 and/or other components and/or layers. The libraries 540 provide functionality that allows other software components to perform tasks more easily than if they interfaced directly with the specific underlying functionality of the (OS) Operating System 536. The libraries 540 may include system libraries 548, such as a C standard library. The system libraries 548 may provide functions such as memory allocation functions, string manipulation functions, mathematical functions, and the like.

In addition, the libraries 540 may include API libraries 550 and other libraries 538. The API libraries 550 may include media libraries, such as libraries to support presentation and manipulation of various media formats such as MPREG4, H.264, MP3, AAC, AMR, JPG, and PNG. The API libraries 550 may also include graphics libraries, for instance an OpenGL framework that may be used to render 2D and 3D in a graphic content on screen 504. The API libraries 550 may further include database libraries, for instance SQLite, which may support various relational database functions. The API libraries 550 may additionally include web libraries, for instance WebKit, which may support web browsing functionality, and also libraries for the applications 526.

The frameworks/middleware 546 may provide a higher-level common infrastructure that may be used by the applications 526 and/or other software components/modules. For example, the frameworks/middleware 546 may provide various Graphical User Interface (GUI) functions, high-level resource management, high-level location services, and so forth. The frameworks/middleware 546 may provide a broad spectrum of other APIs that may be used by the applications 526 and/or other software components/modules, some of which may be specific to the (OS) Operating System 536 or to a platform.

The application programs 526 are also known more simply as applications and apps. One such app is a browser 544, which is a software that can permit user 552 to access other devices on the Internet, for example while using a Graphical User Interface (GUI). The browser 544 includes program modules and instructions that enable the computer system 514 to exchange network messages with a network, for example using Hypertext Transfer Protocol (HTTP) messaging.

The application programs 526 may include one or more custom application programs 542, made according to embodiments. These can be made so as to cause their host computer to perform operations according to embodiments. Of course, when implemented by software, operations according to embodiments may be implemented much faster than may be implemented by a human mind; for example, tens or hundreds of such operations may be performed per second according to embodiments, which is much faster than a human mind can do.

Other such applications 526 may include a contacts application, a book reader application, a location application, a media application, a messaging application, and so on. The applications 526 may be developed using the ANDROID™ or IOS™ Software Development Kit (SDK) by an entity other than the vendor of the particular platform and may be mobile software running on a mobile operating system. The applications 526 may use built-in functions of the (OS) Operating System 536, of the libraries 540, and of the frameworks/middleware 546 to create user interfaces for the user 552 to interact with.

The computer system 514 moreover includes a bus bridge 528 coupled to the system bus 556. The computer system 514 furthermore includes an input/output (I/O) bus 554 coupled to the bus bridge 528. The computer system 514 also includes an I/O interface 530 coupled to the I/O bus 554.

For being accessed, the computer system 514 also includes one or more Universal Serial Bus (USB) ports 532. These can be coupled to the I/O interface 530. The computer system 514 further includes a media tray 534, which may include storage devices such as CD-ROM drives, multi-media interfaces, and so on.

The computer system 512 may include many components similar to those of the computer system 514, as seen in FIG. 5. In addition, a number of the application programs 526 may be more suitable for the computer system 512 than for the computer system 514.

The computer system 512 further includes peripheral I/O devices for being accessed by a user more routinely. As such, the computer system 512 includes the screen 504 and a video adapter 502 to drive and/or support the screen 504. The video adapter 502 is coupled to the system bus 556.

The computer system 512 also includes a keyboard 506, a mouse 508, and a printer 510. In this example, the keyboard 506, the mouse 508, and the printer 510 are directly coupled to the I/O interface 530. Sometimes this coupling is via USB ports, such as the USB ports 532.

In this context, “machine-readable medium” or “computer-readable media” refer to a component, device, or other tangible media able to store instructions and data temporarily or permanently and may include, but is not limited to, a portable computer diskette, a thumb drive, a hard disk, random-access memory (RAM), read-only memory (ROM), buffer memory, flash memory, optical media, magnetic media, cache memory, Erasable Programmable Read-Only Memory (EPROM), an optical fiber, portable compact disc read-only memory (CD-ROM), an optical storage device, a magnetic storage device, or any suitable combination of the foregoing. The machine that would read such a medium includes one or more processor(s) 516.

The term “machine-readable medium” or “computer-readable media” should be taken to include a single medium or multiple media (e.g., a centralized or distributed database, or associated caches and servers) able to store instructions that a machine such as a processor can store, erase, or read. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methods described herein. Accordingly, instructions transform a general, non-programmed machine into a particular machine programmed to carry out the described and illustrated functions in the manner described.

A computer-readable signal traveling from, to, and via these components may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

FIG. 6 is a schematic illustration of a system arranged in accordance with examples described herein. FIG. 6 is a diagram for an operational example where a buy-sell transaction 646 is a use case of the relationship instance 152 of FIG. 1. The transaction 646 is conducted between a primary entity 638, which is a seller, and a secondary entity 644, which is a buyer. A historical tax obligation 626 often arises from the transaction 646 – in particular a sales and/or use tax is to be paid by either the primary entity 638 or the secondary entity 644. A computation of the historical tax obligation 626 is a use case of producing the resource 126 of FIG. 1.

In some examples, based on receipt of one or more new tax and/or fee obligation rules, such as new rule 662, a new tax obligation 622 may arise from the transaction 646 – in particular a sales and/or use tax is to be paid by either the primary entity 638 or the secondary entity 644. A computation of the new tax obligation 622 is a use case of producing the new resource 166 of FIG. 1.

It will be recognized that aspects of FIG. 6 have similarities with aspects of FIG. 1. Portions of such aspects may be implemented as described for analogous aspects of FIG. 1. In particular, a thick horizontal line 602 separates FIG. 6, although not completely or rigorously, into a top portion and a bottom portion. Above the line 602 are shown elements with emphasis mostly on entities, components, their relationships, and their interactions, while below the line 602 are shown elements with emphasis mostly on processing of data that takes place often within one or more of the components that are above the line 602.

Above the line 602, a computer system 642 is shown, which is used to help customers, such as a user 636, with tax compliance. For instance, the user 636 may log into the computer system 642 by using credentials, such as a username, a password, a token, and so on. Further in this example, the computer system 642 is part of an (OSP) online software platform 648 that is implemented as a Software as a Service (SaaS) provider for being accessed by the user 636 online. As such, the (OSP) online software platform 648 can be an online software provider for clients. Alternately, the functionality of the computer system 642 may be provided locally to a user.

The user 636 may be standalone. The user 636 may use a computer system 632 that has a screen 634. In embodiments, the user 636 and the computer system 632 are considered part of the primary entity 638, which is also known as entity 638. The primary entity 638 can be a business, such as a seller of items, a reseller, a buyer, a service business, and so on. In such instances, the user 636 can be an employee, a contractor, or otherwise an agent of the entity 638. In use cases the entity 638 is a seller, the secondary entity 644 is a buyer, and together they are performing the buy-sell transaction 646. The buy-sell transaction 646 may involve an operation, such as an exchange of data to form an agreement. The buy-sell transaction 646 may involve the sale of a product and/or service. This operation can be performed in person, or over a network 628, etc. In such cases the entity 638 can even be an online seller, but that is not necessary. The transaction 646 may, in some examples, have data that is known to the entity 638, similarly with what was described by the relationship instance 152 of FIG. 1.

In a number of instances, the user 636 and/or the entity 638 use software applications to manage their business activities, such as sales, resource management, production, inventory management, delivery, billing, and so on. The user 636 and/or the entity 638 may further use accounting applications to manage purchase orders, sales invoices, refunds, payroll, accounts payable, accounts receivable, and so on. Such software applications, and more, may be used locally by the user 636, or from an Online Processing Facility (OPF) 630 that has been engaged for this purpose by the user 636 and/or the entity 638. In such use cases, the OPF 630 can be a Mobile Payments system, a Point Of Sale (POS) system, an Accounting application, an Enterprise Resource Planning (ERP) provider, an e-commerce provider, an electronic marketplace, a Customer Relationship Management (CRM) system, and so on.

Businesses have tax obligations to various tax authorities of respective tax jurisdictions. These tax obligations are challenging. A first challenge is in making the related determinations. Tax-related determinations, made for the ultimate purpose of tax compliance, are challenging because the underlying statutes and tax rules and guidance issued by the tax authorities are very complex. There are various types of tax, such as sales tax, use tax, excise tax, and value-added tax, and issues about cross-border taxation including customs and duties, and many more. Some types of tax are industry-specific. Each type of tax has its own set of rules. Additionally, statutes, tax rules, and rates change often, and new tax rules are continuously added. Compliance becomes further complicated when a taxing authority offers a temporary tax holiday, during which certain taxes are waived.

Tax jurisdictions are defined mainly by geography. Businesses have tax obligations to various tax authorities within the respective tax jurisdictions. There are various tax authorities, such as that of a group of countries, of a single country, of a state, of a county, of a municipality, of a city, of a local district such as a local transit district, and so on. So, for example, when a business sells items in transactions that can be taxed by a tax authority, the business may have the tax obligations to the tax authority. These obligations include requiring the business to: a) register itself with the tax authority’s taxing agency, b) set up internal processes for collecting sales tax in accordance with the sales tax rules of the tax authority, c) maintain records of the sales transactions and of the collected sales tax in the event of a subsequent audit by the taxing agency, d) periodically prepare a form (“tax return”) that includes an accurate determination of the amount of the money owed to the tax authority as sales tax because of the sales transactions, e) file the tax return with the tax authority by a deadline determined by the tax authority, and f) pay (“remit”) that amount of money to the tax authority. In such cases, the filing and payment frequency and deadlines are determined by the tax authority.

A challenge for businesses is that the above-mentioned software applications generally cannot provide tax information that is accurate enough for the businesses to be tax compliant with all the relevant tax authorities. The lack of accuracy may manifest itself as errors in the amounts determined to be owed as taxes to the various tax authorities, and it is generally not good to have such errors. For example, businesses that sell products and services have risks whether they over-estimate or under-estimate the sales tax due from a sale transaction. On the one hand, if a seller over-estimates the sales tax due, then the seller collects more sales tax from the buyers than was due. Of course, the seller may not keep this surplus sales tax, but instead is to pay it to the tax authorities – if the seller cannot refund it to the buyers. If a buyer later learns that they paid unnecessarily more sales tax than was due, the seller risks at least harm to their reputation. Sometimes the buyer will have the option to ask the state for a refund of the excess tax by sending an explanation and the receipt, but that is often not done as it is too cumbersome for the amounts of money involved. On the other hand, if a seller under-estimates the sales tax due, then the seller collects less sales tax from the buyers, and therefore pays less sales tax to the authorities than was actually due. That is an underpayment of sales tax that will likely be discovered later, if the tax authority audits the seller. Then the seller will pay the difference, plus fines and/or late fees, because ignorance of the law is not an excuse. Further, one should note that sales taxes can be considered trust-fund taxes, meaning that the management of a company may be held personally liable for the unpaid sales tax.

For sales in particular, making correct determinations for sales and use tax is even more difficult. There are a number of factors that contribute to its complexity.

First, some state and local tax authorities have origin-based tax rules, while others have destination-based tax rules. Accordingly, a sales tax may be charged from the seller’s location, meaning according to the rules of the tax authority of the seller, or from the buyer’s location, meaning according to the rules of the tax authority of the buyer.

Second, the various tax authorities assess different, e.g., non-uniform, percentage rates of the sales price as sales tax, for the purchase and sale of items that involve their various tax jurisdictions. These tax jurisdictions include various states, counties, cities, municipalities, special taxing jurisdictions, and so on. As the United States switched, largely but not completely, from primarily origin-based sales tax to destination-based tax, the number of tax jurisdictions rapidly multiplied, and the incentives for local governments to implement new and varied tax rules and ever smaller jurisdictions multiplied. As such, there are over 10,000 different tax jurisdictions in the United States, with many partially overlapping. Their sizes vary from as large as many square miles to as small as a single building. In parallel, tens of thousands of tax rules and tax rates have been developed.

Third, in some instances no sales tax is due at all because of the type of item sold. For example, in 2018 selling cowboy boots was exempt from sales tax in Texas, but not in New York. This non-uniformity gives rise to numerous individual taxability rules related to various products and services across different tax jurisdictions.

Fourth, in some instances no sales tax is due at all because of who the individual buyer is and/or what the purchase is for. For example, certain entities are exempt from paying sales tax on their purchases, as long as they properly create and sign an exemption certificate and give it to the seller for each purchase made. Entities that are entitled to such exemptions may include wholesalers, resellers, non-profit charities, educational institutions, etc. Of course, who can be exempt is not exactly the same in each tax jurisdiction. And, even when an entity is entitled to be exempt, different tax jurisdictions may have different requirements for the certificate of exemption to be issued and/or remain valid. And certificates of exemption may expire after some time and may need to be renewed or reissued.

Fifth, it can be hard to determine which tax authorities a seller owes sales tax to. A seller may start with tax jurisdictions that it has a physical presence in, such as a main office, a distribution center or warehouse, an employee working remotely, and so on. Such ties with a tax jurisdiction establish the so-called physical nexus. However, a tax authority such as a state or even a city may set its own nexus rules for when a business is considered to be “engaged in business” with it, and therefore that business is subject to registration and collection of sales taxes. These nexus rules may include different types of nexus, such as affiliate nexus, click-through nexus, cookie nexus, economic nexus with thresholds, and so on. For instance, due to economic nexus, a remote seller may owe sales tax for sales made in the jurisdiction that are a) above a set threshold volume, and/or b) above a set threshold number of sales transactions.

The economic nexus mentioned above can be even more complicated. Even where a seller might not have reached any of the thresholds for economic nexus, a number of states are promulgating marketplace facilitator laws that sometimes use such thresholds. According to such laws, intermediaries that are characterized as marketplace facilitators per laws of the state may have an obligation, instead of the seller, to collect sales tax on behalf of their sellers and remit it to the state. The situation becomes even more complex when a seller sells directly to a state and also via such an intermediary.

In some examples, at the time of calculating taxes, nexus may need to be there for an OSP to calculate a specific type of tax for a specific jurisdiction and/or tax authority. In examples, when an OSP, such as the OSP 320, compares and/or scans through all (and/or many and/or some) of the latest tax laws (e.g., rules, etc.) and finds (e.g., and/or determines, etc.) that the transaction data demand (e.g., require, etc.) a certain type of tax to be calculated for which customer has not set up nexus, based on a pre-consent from the customer (e.g., stored in, for example, the customer consent and registrations 333), the OSP, such as the OSP 320, may be configured to set up nexus for the customer.

Moreover, with the increasing frequency at which existing resource obligation rules change and new resource obligation rules are introduced, coupled with the existence of numerous, unique regulations across many different jurisdictions, such factors create an environment in which accurate tax and/or fee liability obligation calculation and collection, as well as accurate and timely tax return reporting, becomes challenging. Businesses often cannot stay current with existing and new tax laws and the different types of taxes and respective filing needs. Inaccurate resource obligation calculation, collection, and/or reporting may each individually, as well as together in combination, result in negative, costly consequences.

To help with such complex determinations, the computer system 642 may be specialized for tax compliance. The computer system 642 may have one or more processors and memory, for example, as was described for the computer system 148 of FIG. 1. The computer system 642 thus implements a tax engine 640 to make the determinations of tax obligations. The tax engine 640 can be as described for the service engine 128.

The computer system 642 may further store local entity data, e.g., data of the user 636 and/or of the entity 638, either of which/whom may be a customer, and/or a seller or a buyer in a sales transaction. The entity data may include profile data of the customer and transaction data from which a determination of a tax obligation is desired. In the online implementation of FIG. 6, the (OSP) online software platform 648 has a database 652 for storing the entity data. This entity data may be inputted by the user 636, and/or caused to be downloaded or uploaded by the user 636 from the computer system 632 or from the OPF 630 or extracted from the computer system 632 or from the OPF 630, and so on. In other implementations, a simpler memory configuration may suffice for storing the entity data.

A digital tax content 604 is further implemented within the (OSP) online software platform 648. The digital tax content 604 can be a utility that stores digital tax and/or fee obligation rules 614 for use by the tax engine 640. As part of managing the digital tax content 604, there may be periodic and/or continuous updates of the digital tax rules, by inputs gleaned from a set 654 of different tax authorities 656, 658, etc. Updating may be performed by humans and/or by computers. As mentioned above, the number of the different tax authorities in the set 654 may be very large. In such use cases, tax jurisdictions such as a country, a state, a city, a municipality, etc. correspond to domains discussed earlier in this document.

For a specific determination of a tax obligation, the computer system 642 may receive one or more datasets. A sample received dataset 608 is shown just below line 602. The dataset 608 has values that can also be called dataset values and be otherwise examples of what was described for the dataset values of the dataset 110 of FIG. 1. In this example, the computer system 632 transmits a request 624 that includes a payload 606, and the dataset 608 is received by the computer system 642 parsing the received payload 606. In this example the single payload 606 encodes the entire dataset 608, but that is not required, as mentioned above. The dataset 608 may include transaction data for one or more transactions. For example, the dataset 608 may include one or more invoices.

In this example, the dataset 608 has been received because it is desired to determine any tax obligations arising from the buy-sell transaction 646. As such, the sample received dataset 608 has values that characterize attributes of the buy-sell transaction 646, as indicated by a correspondence arrow 650. Accordingly, in this example the sample received dataset 608 has a value ID for an identity of the dataset 608 and/or the transaction 646. The dataset 608 also has a value PE for the name of the primary entity 638 or the user 636, which can be the seller making sales transactions, some perhaps online. The dataset 608 further has an optional value PD for relevant data of the primary entity 638 or the user 636, such as an address, place(s) of business, prior nexus determinations with various tax jurisdictions, and so on. The value PD is optional because it may be possible to look it up from the value PE. The dataset 608 also has a value SE for the name of the secondary entity 644, which can be the buyer. The dataset 608 further has a value SD for relevant data of the secondary entity 644, entity-driven exemption status, and so on. In some instances, the value SD can be optional, similarly with the value PD. The dataset 608 has a numerical value B2 for the sale price of the item sold. The dataset 608 may further have additional dataset values, as indicated by the dot-dot-dot in the right side of the dataset 608. These values may characterize further attributes, such as what item was sold, for example, by a Stock Keeping Unit (SKU), how many units of the item were sold in the transaction 646, a date and possibly also time of the transaction 646, and so on.

The digital tax and/or fee obligation rules 614 are digital in that they are implemented for use by software, similarly with rules 118 of FIG. 1. The digital tax and/or fee obligation rules 614 can be created so as to accommodate legal tax rules that the set 654 of different tax authorities 656, 658, etc. promulgate to apply within the boundaries of their tax jurisdictions. In the example of this diagram, two sample digital tax rules are shown explicitly, namely existing rule 618 and the new rule 662. The existing rule 618 may be an existing resource obligation rule, and the new rule 662 may be a newly received, identified, and/or detected resource obligation rule. In this diagram, all other such rules are indicated by the vertical dot-dot-dots. These digital resource rules 614 are digital in that they are implemented for use by software. For example, these digital resource rules 614 may be implemented within the computer system 642 and/or the tax engine 640. The data portion of these digital resource rules 614 may alternatively be stored in memories that are local or in other places that can be accessed by the computer system 642. The storing can be in the form of a spreadsheet, a database, etc.

Then the computer system 642 may select certain one(s) of the digital tax rules 614. In some examples, the existing rule 618 may be selected. In some examples, the tax rule(s) may be selected by first selecting a transaction scenario as described herein. The selection of this particular rule is indicated also by the fact that an arrow 624 begins from that rule. The arrow 624 is similar to the arrow 124.

The computer system 642 may thus select the existing rule 618 responsive to one or more of the dataset values of the dataset 608. The impact of the dataset 608 in the selection is indicated by at least some of arrows 616, similarly with the arrows 120. For example, it can be recognized that a condition of the existing rule 618 is met by one or more of the values of the dataset 608. For instance, it can be further determined that, at the time of the sale, the buyer is located within the boundaries of a tax jurisdiction, that the seller has nexus with that tax jurisdiction, and that there is no tax holiday.

As such, the computer system 642 may produce the historical tax obligation 626, which is akin to producing the resource 126 of FIG. 1. The historical tax obligation 626 can be produced by the computer system 642 applying the certain existing rule 618, as indicated by the arrow 624. The impact of the dataset 608 in producing the historical tax obligation 626 is indicated by at least one of the arrows 616. In this example, the identified certain existing rule 618 may specify that a sales tax is due, the amount is to be determined by a multiplication of the sale price of the value B2 by a specific rate, the tax return form that needs to be prepared and filed, a date by which it needs to be filed, and so on.

In embodiments, the computer system 642 may select other certain one(s) of the accessed digital resource rules 614. In some examples, the new rule 662 may be selected as the certain digital resource rule. In some examples, the new rule 662 may be selected as a new resource obligation rule to replace the existing rule 618 as the existing (e.g., historical, old, outdated) resource obligation rule. The selection of this particular rule is indicated also by the fact that an arrow 664 begins from that rule.

The computer system 642 may thus select the new rule 662 responsive to one or more of the dataset values of the dataset 608. The impact of the dataset 608 in the selection may be indicated by at least some of the arrows 616.

In embodiments, the computer system 148 may select other certain one(s) of the accessed digital resource rules 614, such as the new rule 662, and may be based further on determining and/or obtaining and/or accessing an authorization, such as an authorization from the user 636 and/or the primary entity 638.

In embodiments, upon detection, identification, and/or receipt of the new rule 662 in the digital resource rules 614, the OSP 648 may transmit a new tax and/or fee liability authorization alert, such as new tax and/or fee liability authorization alert 668 (such as the authorization alert depicted in user interface 804 on screen 802 of FIG. 8), to the user 636. The user 636 may make selections (e.g., via one or more interactive methods, including buttons, touch regions, spoken word, etc.) authorizing one, both, or none of (1) upon calculating a new resource obligation based on a new resource obligation rule, preparing a new data output as required, and (2) if user is not registered for the data output, registering the user using the user’s business information.

In embodiments, upon receipt of a new tax and/or fee liability authorization grant, such as new tax and/or fee liability authorization grant 670, the computer system 642 may select the new rule 662.

Then the computer system 642 may produce a new resource for the dataset 608, such as the new tax obligation 622. The computer system 642 may thus produce the new tax obligation by applying the new rule 662, which was previously selected, to at least one of the dataset values of the dataset 608. In the example of FIG. 6, the new tax obligation 622 is produced for the dataset 608 by the computer system 642 applying the new rule 662, as indicated by the arrow 664, similar to arrow 164 of FIG. 1. The impact of the dataset 608 in producing the new tax obligation 622 is indicated by at least one of the arrows 616.

The computer system 642 may then cause a notification 610 to be transmitted. In the example of FIG. 6, the notification 610 is caused to be transmitted by the computer system 642 as an answer to the received dataset 608. The notification 610 can be about an aspect of the historical tax obligation 626 and/or about the new tax obligation 622, similarly with the notification 112 of FIG. 1. For instance, the notification 610 may inform that the historical tax obligation 626 has been determined, where it can be found, what it is, or at least a portion or a statistic of its content, and so on. The notification 610 may further inform that the new tax obligation 622 has been determined, where it can be found, what it is, or at least a portion or a statistic of its content, and so on.

The notification 610 can be transmitted to one of an output device and another device that can be the remote device, from which the dataset 608 was received. The output device may be the screen of a local user or a remote user. The notification 610 may thus cause a desired image to appear on the screen, such as within a Graphical User Interface (GUI) and so on. The other device may be a remote device, as in this example. In particular, the computer system 642 causes the notification 610 to be communicated by being encoded as a payload 612, which is carried by a response 672. The response 672 may be transmitted via the network 628 responsive to the received request 624. The response 672 may be transmitted to the computer system 632, or to the OPF 630, and so on. As such, the other device can be the computer system 632, or a device of the OPF 630, or the screen 634 of the user 636, and so on. In this example the single payload 612 encodes the entire notification 610, but that is not required, similarly with what is written above about encoding datasets in payloads. Of course, along with the aspect of the historical tax obligation 626, it is advantageous to embed in the payload 612 the ID value and/or one or more values of the dataset 608. In some examples, this will help the recipient correlate the response 672 that they receive to their request 624 and therefore match the received aspect of the historical tax obligation 626 as the answer to the transmitted dataset 608. In some examples, this will help the recipient correlate the response 672 that they receive to their request 624, and therefore match the received aspect of the new tax obligation 622.

The digital tax rules 614 can be implemented or organized in different ways. For example, these digital tax rules 614 may have applicability conditions that relate to geographical boundaries, effective dates with possible temporary exceptions, item classification into categories, differently treated parties, and so on, for determining where and when a certain digital tax rule 614 is to be selected and applied, to determine the historical tax obligation 626 and/or the new tax obligation 622. These conditions may be expressed as logical conditions with ranges, dates, other data, and so on. Values of the dataset 608 can be iteratively tested against these logical conditions according to the arrows 616. In such cases, the applicable tax rules may indicate how to compute one or more tax obligations, such as to indicate different types of taxes that are due, rules, rates, exemption requirements, reporting requirements, remittance requirements, the actual amounts of tax obligations, etc.

As with the digital resource rules 118, the digital tax rules 614 may also be complex. While a certain one of them is eventually selected and applied to determine the tax obligation, more than one of them may be used for selecting that certain one.

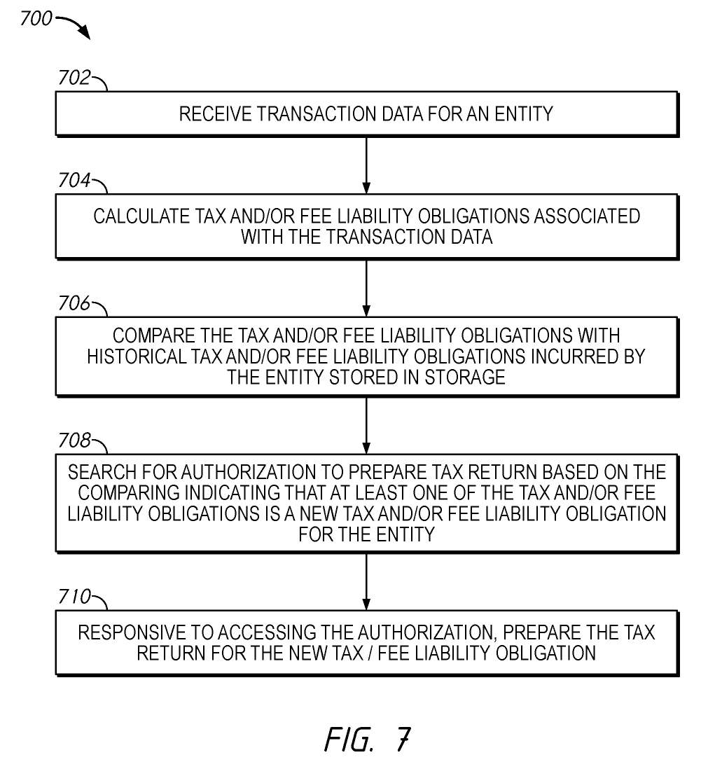

FIG. 7 is a flowchart illustrating an example method 700 arranged in accordance with examples described herein.

The method 700 includes receiving transaction data for an entity in block 702, calculating tax and/or fee liability obligations associated with the transaction data in block 704, comparing the tax and/or fee liability obligations with historical tax and/or fee liability obligations incurred by the entity stored in storage in block 706, searching for authorization to prepare tax return based on the comparing indicating that at least one of the tax and/or fee liability obligations is a new tax and/or fee liability obligation for the entity in block 708, and, responsive to accessing the authorization, preparing the tax return for the new tax and/or fee liability obligation in block 710.

Block 702 recites receiving transaction data for an entity. In some examples, the transaction data for the entity may be received by the front end 332 of the OSP 320 of FIG. 3. In some examples, the transaction data may be received from the computer 314 of the enterprise 301 of FIG. 3. In some examples, the transaction data may be received from the user 312 using the computer 314 of the enterprise 301 of FIG. 3. In some examples, the transaction may be transmitted over a network, such as one or more networks described herein. In some examples, the transaction data may be received by one or more other components, such as one or more additional and/or alternative components of FIG. 3. In some examples, the transaction data may be derived from a transaction conducted between a primary entity (e.g., the primary entity 638 of FIG. 6), which is a seller, and a secondary entity (such as the secondary entity 644 of FIG. 6), which is a buyer. In some examples, the transaction data may be derived from a transaction conducted between a customer and a seller. In some examples, the transaction data may be derived from a transaction conducted between a customer and a business.

Block 704 recites calculating tax and/or fee liability obligations associated with the transaction data. In some examples, one or more components of the OSP 320 of FIG. 3 may calculate the tax and/or fee liability obligations associated with the transaction data. For example, in some examples, the computation engine 335 of FIG. 3 may be configured to calculate the tax and/or fee liability obligations associated with the transaction data. In some examples, the computation engine 335 of FIG. 3 may calculate the tax and/or fee liability obligations associated with the transaction data using one or more rules, such as tax and/or fee liability obligation rules. In some examples, the computation engine 335 of FIG. 3 may calculate the tax and/or fee liability obligations associated with the transaction data using the digital tax rules 338 of FIG. 3. In some examples, the computation engine 335 of FIG. 3 may calculate the tax and/or fee liability obligations associated with the transaction data using information and/or data and/or metadata stored in other storage locations of FIG. 3, such as, for example, the historical transaction data 341 and/or the new/changed liability database 354 of FIG. 3.

In some examples, the digital resource rules (e.g., resource obligation rules, new resource obligation rules, fee rules, tax rules, etc.) may be received by the OSP 320 at the tax content front end 361. In some examples, the tax content front end 361 may receive the digital tax and/or fee obligation rules by one or more entities and/or authorities, such as the tax authorities 360 of FIG. 3 and/or the rule system 391 and/or the tax researcher 392 by way of the computer 394 of FIG. 3.

Block 706 recites comparing the tax and/or fee liability obligations with historical tax and/or fee liability obligations incurred by the entity stored in storage. In some examples, one or more component of FIG. 3 may be configured to compare the tax and/or fee obligation with historical tax and/or fee obligation incurred by the entity stored in storage. For example, the computation engine 335 may be configured to compare the tax and/or fee obligation with historical tax and/or fee obligation incurred by the entity. In some examples, the historical tax and/or fee obligations that the computation engine 335 compares may be stored in one or more locations of, for example, FIG. 3. In some examples, the historical tax and/or fee obligations that the computation engine 335 compares may be stored in the historical transaction data 341.

Block 708 recites searching for authorization to prepare (and/or complete and/or fill out) one or more tax return(s) (and/or forms, etc.) based on the comparing indicating that at least one of the tax and/or fee liability obligations is a new tax and/or fee liability obligation for the entity. In some examples, one or more components of an OSP system, such as the OSP 320 of FIG. 3, may be configured to search for authorization to prepare the one or more tax return(s). In some examples, the notification service 356 may be configured to search for authorization to prepare the one or more tax return(s). In some examples, the notification service 356 may be configured to transmit an authorization alert to a user/entity/business/customer (such as the alert of FIG. 8), receive a completed authorization grant in response to the authorization alert, and/or store the authorization grant in storage, such as the customer consent and registrations 333. In some examples, the notification service 356 may be configured to register the user/entity/business/customer based on receipt of the completed authorization grant. In some examples, the notification service 356 may be configured to register the user/entity/business/customer with an entity (e.g., a government authority) such as the tax authorities 360 of FIG. 3.

In some examples, the tax return preparation service 383 may be configured to search for the authorization grant (e.g., pre-consent, pre-consent authorization, etc.) stored in the customer consent and registrations 333. In some examples, the tax return preparation service 383 may be configured to search for user/entity/business/customer registration in the customer consent and registrations 333. In some examples, the notification service 356 may receive a completed authorization grant in response to the authorization alert, at the front end 332.

Block 710 recites responsive to accessing the authorization, preparing the tax return for the new tax and/or fee liability obligation. In some examples, responsive to accessing the authorization information in, for example, the customer consent and registrations 333, the tax return preparation service 383 may be configured to prepare the one or more tax return(s) for the new tax and/or fee obligation. In some examples, the one or more tax return(s) for the new tax and/or fee obligation may comprise the completion of a new form, such as a new tax form. In some examples, the one or more tax return(s) for the new tax and/or fee obligation may comprise the completion of a new line item on one or more existing form(s). In some examples, the one or more tax return(s) for the new tax and/or fee obligation may comprise updating one or more old line item(s) on one or more existing form(s). In some examples, the tax return preparation service 383 may store the one or more tax return(s) in one or more storage locations, such as those illustrated in the OSP 320 of FIG. 3. For example, the tax return preparation service 383 may store the one or more tax return(s) in the tax returns data 381.

The tax return submission service 385 may file/upload/submit the one or more tax return(s). In some examples, the tax return submission service 385 may file/upload/submit the one or more tax return(s) (e.g., one or more forms) to one or more entities, such as with the tax authorities 360. In some examples, the tax return submission service 385 may file/upload/submit the one or more tax return(s) to one or more entities, such as one or more local, state, federal, etc. governmental entities and/or agencies and/or departments.

In examples, the storage accessible to the online software platform may comprise historical tax and/or fee liability obligations incurred by one or more entities, including the entity. In some examples, historical tax and/or fee obligations incurred by one or more entities may be stored at the historical transaction data 341. In some examples, the storage may further comprise authorizations for at least one of the one or more entities, including the entity. In some examples, authorizations for at least one of the one or more entities may be stored at the customer consent and registrations 333. In some examples, the storage accessible to the online software platform may comprise one or more tax and/or fee liability obligations, including, in some examples, the tax and/or fee liability obligations associated with the transaction data. In examples, the tax and/or fee liability obligation may be associated with an existing tax and/or fee liability obligation rule. In some examples, one or more tax and/or fee liability obligations, including, in some examples, the tax and/or fee liability obligations associated with the transaction data may be stored at the digital tax rules 338 and/or the historical transaction data 341 and/or the tax forms database 339 and/or the new/changed liability database 354, among others. In examples, the tax and/or fee liability obligation may be associated with an existing tax and/or fee liability obligation rule.

In examples, upon receipt of a new tax and/or fee liability obligation rule, such as at the tax content front end 361, the online software platform, such as the OSP 320, may store the new tax and/or fee liability obligation rule for utilization in the calculation, determination, and or collection of tax and/or fee liability obligations (e.g., during a transaction), such as at the digital tax rules 338 and/or the new/changed liability database 354, among other storage locations. For example, the OSP 320 may receive a new tax and/or fee liability obligation rule associated with the tax and/or fee liability obligation at the tax content front end 361. In some examples, the OSP 320, via the new/changed liability analyzer 351, may compare the new tax and/or fee liability obligation rule with the existing tax and/or fee liability obligation rule, and, based on a determination that the new tax and/or fee liability obligation rule is different from the existing tax and/or fee liability obligation rule, replace the existing tax and/or fee liability obligation rule with the new tax and/or fee liability obligation rule. In some examples, the new tax and/or fee liability obligation may be based, at least in part, on the new tax and/or fee liability obligation rule. In some examples, the new tax and/or fee liability obligation rule may be stored at the new/changed liability database 354. In some examples, the new tax and/or fee liability obligation rule may be stored at the digital tax rules 338. In some examples, the new tax and/or fee liability obligation rule may be stored at one or more other storage locations.

In some examples, upon receipt of a new tax and/or fee liability obligation rule, OSP 320 (and/or OSP 154 of FIG. 1) may be configured to determine whether the data (e.g., transaction data) obtained in a transaction with an entity (e.g., user, business, etc.) and/or any other data obtained and/or already stored at one or more components of OSP 320 is sufficient for determining (e.g., calculating) the new tax and/or fee liability obligation.

In some examples, OSP 320 may automatically determine that the data obtained the data (e.g., transaction data) obtained in a transaction with an entity (e.g., user, business, etc.) and/or any other data obtained and/or already stored at one or more components of OSP 320 is sufficient.

In some examples, OSP 320 may automatically determine that the data obtained the data (e.g., transaction data) obtained in a transaction with an entity (e.g., user, business, etc.) and/or any other data obtained and/or already stored at one or more components of OSP 320 is insufficient (e.g., that additional information not currently in storage and/or collected via a transaction is needed).

In examples where a connector and/or an extractor is present that obtains data from an entity (e.g., a user, customer, etc.), an ERP or similar system (e.g., ERP or similar 558 of FIG. 5) may configure (and/or re-configure) the connector (such as connector 560 of FIG. 5) and/or extractor to collect and/or obtain the additional data needed (e.g., a new subset of data). In some examples, an OSP, such as OSP 154, and/or the ERP system, may configure and/or re-configure and/or update the connector (e.g., connector 560 of FIG. 5) at connector config update 168 of FIG. 1.

In examples where a manual upload (or similar) from an entity (e.g., a user, customer, etc.) is used as an alternative and/or in addition to the one or more connectors, an OSP such as OSP 154 may be configured to send an alert to the entity (e.g., the user, customer, etc.) indicating that missing and/or outstanding subset of data (e.g., data points) are need collecting manually, such as at data required notification 170 of FIG. 1.

In examples, an online software platform, such as the OSP 320 of FIG. 3, may determine that one or more of the new taxes and/or fee liability obligation rules requires registration. In some examples, the notification service 356 of FIG. 3 may be configured to determine that one or more of the new tax and/or fee liability obligation rules requires registration. In some examples, such registration may include registration with a domain(s) for at least one of the one or more entities, such as a governmental entity. In some examples, the online software platform may register at least one of the one or more entities with the domain upon receipt, identification, and/or accessing of the authorization(s). In some examples, the tax return preparation service 383 may be configured to register at least one of the one or more entities with the domain. In some examples, the computation engine 335 may be configured to register at least one of the one or more entities with the domain. In some examples, the notification service 356 may be configured to register at least one of the one or more entities with the domain. In some examples, one or more components, such as but not limited to the tax return preparation service 383, the computation engine 335 and/or the notification service 356 may be configured to store confirmation of the registration. In some examples, the confirmation of the registration may be stored in the customer consent and registrations 333.

In some embodiments, when a new tax and/or fee liability rule requires a new registration, the new registration may require additional and/or alternative information and/or data to complete. Such data and/or information may be stored at or in one or more components of OSP 320, such as one or more databases 339, 341, 354, 333, and/or 381. In some examples, OSP 320 may determine that the information and/or data stored and/or present in OSP 320 is insufficient to complete the new registration. In some examples, OSP 320 may determine that some information and/or data stored and/or present in OSP 320 may be used for the registration, but that a subset of data necessary to complete the registration is not present.

In response, OSP 320 may, in some examples, automatically modify and/or adapt the data transaction collection workflow (e.g., such as registration workflow 395 of FIG. 3) such that it collects the subset of missing data needed to complete registration (e.g., needed from a user, entity, business, customer, etc.). In some examples, OSP may prompt the user, entity, business, and/or customer for the subset of data via one or more methods, such as via email, web form, alert, and the like. In some examples, a data required notification, such as data required notification 170 of FIG. 1, may be sent via and OSP, such as OSP 154 of FIG. 1, to a user, such as user 142 of FIG. 1. In some examples, OSP 320 may be configured to store the newly collected (and/or received) subset of data at and/or in one or more components of OSP 320, such as one or more databases 339, 341, 354, 333, and/or 381. In some examples, OSP 320 may be configured to use the subset of data to complete and/or submit the (new) registration to a domain, such as a government entity.

In examples, upon receipt of a new tax and/or fee liability obligation rule, an online software platform, such as the notification service 356 of the OSP 320 of FIG. 3, may generate an authorization alert for a user (and/or a business and/or an entity). In some examples, the online software platform may receive via the authorization alert (e.g., an authorization alert completed by a user, business, and/or entity) one or more authorizations from one or more entities to prepare the one or more tax returns. In some examples, once authorization is obtained and/or accessed, the online software platform may prepare the tax return for the new tax and/or fee liability obligation. In some examples, the completed authorization grant may be received at the OSP 320 by the front end 332. In some examples, the completed authorization grant may be stored in the customer consent and registrations 333. In some examples, once authorization is obtained and/or accessed, the OSP 320, via in some examples the tax return preparation service 383, may prepare the one or more tax return(s) for the new tax and/or fee obligation.

In this way, systems and methods described herein provide compliance and reporting benefits, including automatically recognizing and calculating new tax and/or fee liability obligations based on new tax and/or fee liability obligation rules, as well as automatically assisting with the tax return reporting needs.

FIG. 8 is a schematic illustration of a user interface arranged in accordance with examples described herein. FIG. 8 depicts user interface (UI) 804 on screen 802. The screen 802 may be used to implement and/or may be implemented by the screen 140 of FIG. 1 in some examples, and/or the computer 314 of FIG. 3, the computer 394 of FIG. 3, the screen 504 of FIG. 5, and/or the screen 634 of FIG. 6. The UI 804 may be an interface to online software platforms described herein, such as the OSP 154 of FIG. 1, the OSP 320 of FIG. 3, and/or the (OSP) online software platform 648 of FIG. 6.

The UI 804 depicted in FIG. 8 is exemplary. Additional and/or alternative displayed text and/or interactive elements may be used in other examples.

In the example of FIG. 8, the screen 802 may display options for a user (e.g., an admin of systems, including enterprise systems, described herein), such as, in some examples, the user 142 of FIG. 1, the user 312 of FIG. 3, the user 552 of FIG. 5, and/or the user 636 of FIG. 6, to authorize an online software platform on how to proceed when a new resource obligation rule is detected, identified, and/or received, as described herein.

The screen 802 displays a heading “New Resource Obligation Rule Authorization Alert.” In this manner, online software platforms described herein may seek authorization(s) from enterprises (e.g., client systems, users, etc.) regarding how to proceed when new resource obligation rules are detected, identified, and/or received.

The UI 804 provides radio buttons for a user to select a preferred action responsive to the detection, identification, and/or reception of new resource obligation rules. While radio buttons are shown in FIG. 8, other interactive elements may be used in other examples, such as, for example, one or more buttons, touch regions, or spoken words, or other inputs may be used to make one or more selections of the UI 804 on the screen 802.

In the example of FIG. 8, a user may request that the online software platform automatically prepare a new filing as required, upon calculating a new type of tax. If this selection is made, the online software platform, such as the OSP 154 of FIG. 1, the OSP 320 of FIG. 3, and/or the OSP 648 of FIG. 6, will automatically prepare a new filing upon calculating a new type of tax.

In the example of FIG. 8, a user may request that, if the user is not registered for the new filing, to register the user using business information corresponding to and/or associated with the user (and/or with an enterprise associated with the user). If this selection is made, the online software platform, such as the OSP 154 of FIG. 1, the OSP 320 of FIG. 3, and/or the OSP 648 of FIG. 6, will register the user for the filing using business information corresponding to and/or associated with the user.

It should be appreciated that while each option (e.g., selection) is discussed individually, a user may select both options in the UI 804 on the screen 802, in parallel. For example, a user may select both (1) “upon calculating a new type of tax, automatically prepare the new filing as required,” and (2) “if I am not registered for the new filing, please register me using my business information.” In some examples, a user may select one of the two options in the UI 804 on the screen 802. For example, a user may decide to select only “upon calculating a new type of tax, automatically prepare the new filing as required,” or “if I am not registered for the new filing, please register me using my business information.” In some examples, a user may select none of the options in the UI 804 on the screen 802.

Upon selection of one, both, or none of the options in the UI 804 on the screen 802, a user may request the online software platform apply their selection by the user selecting “apply.”

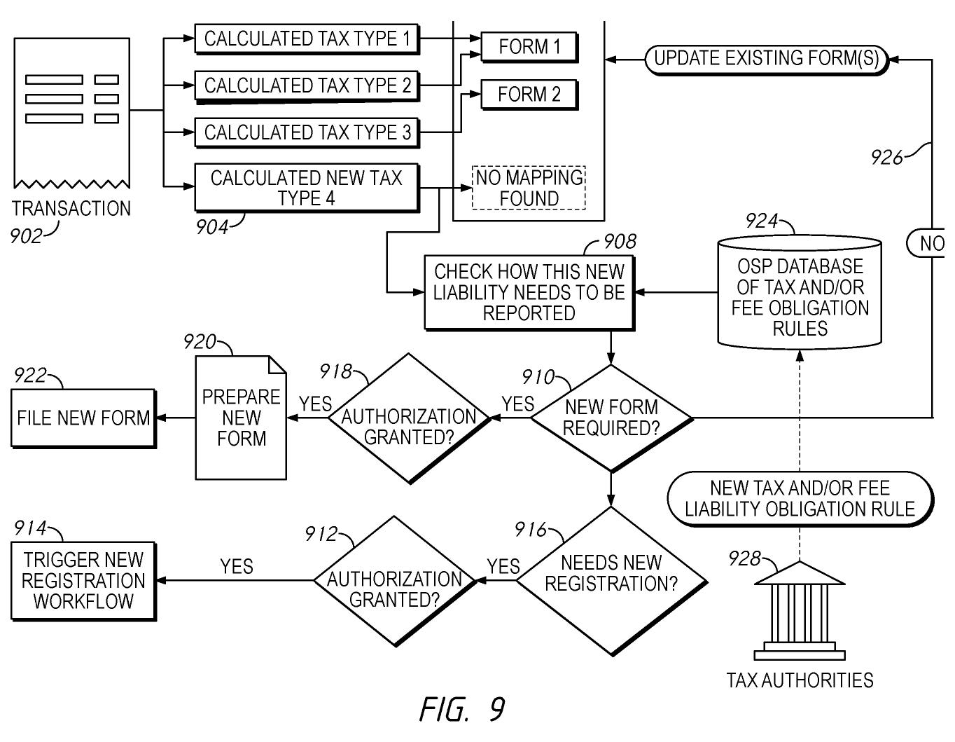

FIG. 9 is a schematic illustration of an example flow diagram arranged in accordance with examples described herein.

At step 902, a transaction may be conducted. In some examples, the transaction may be a buy-sell transaction. In some examples, the transaction may be conducted between a primary entity (such as the primary entity 638 of FIG. 6), which is a seller, and a secondary entity (such as the secondary entity 644 of FIG. 6), which is a buyer. In some examples, the transaction may occur between a user of an enterprise and an OSP system. In some examples, the transaction may occur between the user 312 using the computer 314 of the enterprise 301 of FIG. 3, and the OSP 320 of FIG. 3. At step 902, transaction data related to the transaction that occurred may be received at an OSP, such as the OSP 320.

At step 904, one or more tax types (and/or fee types and/or additional and/or alternative liability types) may be calculated. In some examples, the one or more tax types may be calculated based on the transaction data. In some examples, an OSP, such as the OSP 320, may calculate the one or more tax types. In some examples, a computation engine, such as the computation engine 335 of FIG. 3, may calculate the one or more tax types. In some examples, and as illustrated, the OSP 320 via the computation engine 335 may calculate tax type 1, tax type 2, tax type 3, and/or new tax type 4. As should be appreciated, additional and/or fewer and/or alternative tax types may be calculated at step 904. As should further be appreciated, while only tax types 1-4 are illustrated, other tax types and/or liability types, such as fee types, may be calculated by and/or from and/or utilizing transaction(s) data.

At step 906, one or more of the calculated tax types (e.g., liability types, fee types, etc.) may be mapped to one or more existing forms (e.g., tax forms, tax returns, liability forms, fee forms, etc.). In this example, calculated tax type 1 is mapped to form 1, calculated tax type 2 is mapped to form 2, and calculated tax type 3 is mapped to form 2. In some examples, form 1 and form 2 are existing forms hosted in a storage location, such as one or more storage locations of the OSP 320 of FIG. 3. In some examples, form 1 and form 2 may be stored in the tax forms database 339 of FIG. 3. In some examples, one or more component of an OSP, such as the OSP 320 of FIG. 3, may perform the mapping. In some examples, the computation engine 335 may perform the mapping. In some examples, one or more forms stored in one or more storage locations, such as the tax forms database 339, may be mapped to one or more tax and/or fee types. In some examples, when a tax and/or fee type is calculated, a mapping may exist indicating to the OSP 320 which form the tax type needs to be included on for, for example, reporting and/or other purposes, as described herein.

In some examples, one or more calculated tax types may not map to an existing form such as an existing form in the tax forms database 339. In some examples, one or more calculated tax types may not map to an existing form when the calculated tax type is a new tax type, when the calculated tax type is associated with a new tax and/or fee liability obligation rule, and/or when the calculated tax type is associated with an updated tax and/or fee liability obligation rule.

In the example in FIG. 9, calculated new tax type 4 does not map to an existing form, such as an existing form in the tax forms database 339, as indicated by the dotted box noting “no mapping found.”

At step 906, and in some examples, upon detection that a calculated tax type, such as calculated new tax type 4, does not map to an existing form, such as an existing form in the tax forms database 339, an online software platform, such as the OSP 320, may be configured to check how the calculated tax type needs to/should be/is required to be/is preferred to be reported at step 908. In some examples, the computation engine 335 may be configured to check how the calculated tax type needs to be reported. In some examples, the tax return preparation service 383 may be configured to check how the calculated tax type needs to be reported. In some examples, the notification service 356 may be configured to check how the calculated tax type needs to be reported.

In some examples, the one or more components may utilize information and/or data and/or metadata from one or more databases and/or data repositories and/or storage locations to determine how the calculated tax type needs to be reported. In some examples, OSP database of tax and/or fee obligation rules 924 of FIG. 9 may be accessed and/or utilized to determine how the calculated tax type needs to be reported. In some examples, the digital tax rules 338 of FIG. 3 may be accessed and/or utilized to determine how the calculated tax type needs to be reported. In some examples, the new/changed liability database 354 of FIG. 3 may be accessed and/or utilized to determine how the calculated tax type needs to be reported. In some examples, the tax forms database 339 of FIG. 3 may be accessed and/or utilized to determine how the calculated tax type needs to be reported. In some examples, the OSP database of tax and/or fee obligation rules 924 of FIG. 9 may be updated by one or more entities and/or authorities, such as tax authorities 928. In some examples, the OSP database of tax and/or fee obligation rules 924 of FIG. 9 may be updated with one or more new tax and/or fee liability obligation rule(s) by one or more entities and/or authorities, such as the tax authorities 928.

At step 910, an online software platform, such as the OSP 320 of FIG. 3, may determine whether a new form is needed to map calculated new tax type 4. If no new form is needed, then the tax forms database, such as the tax forms database 339 of FIG. 3, is updated at step 926 to update existing forms, such that the calculated new tax type 4 may be mapped to an updated form.

At step 910, an online software platform, such as the OSP 320 of FIG. 3, may determine whether a new form is needed to map calculated new tax type 4. If a new form is needed, then at step 918 OSP determines whether authorization has been granted to prepare the new form. In some examples, one or more components of the OSP 320 may determine if authorization has been granted. In some examples, the notification service 356 may determine if authorization has been granted. In some examples, the tax return preparation service 383 may determine if authorization has been granted. In some examples, the customer consent and registrations 333 may be accessed to determine if authorization has been granted. In some examples, one or more pre-consents and/or authorizations to prepare one or more new forms (and/or tax returns, etc.) may be stored in the customer consent and registrations 333.

At step 920, a new form may be prepared. In some examples, the tax return preparation service 383 may prepare the new form. The prepared new form may be stored by the tax return preparation service 383 at one or more storage locations, such as at the tax returns data 381. At step 922, the prepared new form may be accessed by the tax return submission service 385. In some examples, and at step 922, the tax return submission service 385 may file (e.g., upload, submit, etc.) the prepared new tax form.

In some examples, prior to preparing and/or filing the prepared new tax form, a user and/or an entity and/or a business and/or a customer may need to register with one or more authorities and/or entities, such as a government entity and/or tax authorities 928. At step 916, an OSP, such as the OSP 320 of FIG. 3, may check whether a new registration is needed. In some examples, the notification service 356 may determine if registration is needed. In some examples the tax return preparation service 383 may determine if registration is needed. If registration is needed, at step 912, one or more components described herein may determine whether the OSP has received authorization to begin a registration process. In some examples, the notification service 356 may determine if authorization has been granted and/or obtained to begin the registration process. In some examples, the customer consent and registrations 333 may be accessed to determine if authorization has been granted to begin the registration process. If registration permission has not been granted one or more components of the OSP 320, such as the notification service 356, may send an authorization alert to a user/entity/customer/business to obtain authorization. Received and/or obtained authorization may be stored by one or more components of the OSP 320 at, in some examples, the customer consent and registrations 333.

At step 914, if it is determined that authorization to start the registration process has been granted, such authorization determination may, in some examples, trigger a new registration workflow to register the user/entity/business/customer with an entity, government, and /or tax authority.

In this way, systems and methods described herein provide compliance and reporting benefits, including automatically recognizing and calculating new resource obligations based on new resource obligation rules, as well as automatically assisting with the resource obligation reporting needs.

Accordingly, aspects of systems and methods and computer readable media are described herein.

In an example aspect, a method includes receiving, at an online software platform, transaction data for an entity, calculating, by the online software platform, resource obligations associated with the transaction data, comparing, by the online software platform, the resource obligations with historical resource obligations incurred by the entity and stored in storage accessible to the online software platform, searching, by the online software platform, for authorization to prepare data output based on the comparing indicating that at least one of the resource obligations is a new resource obligation for the entity, and, responsive to accessing the authorization, preparing, by the online software platform, the data output for the new resource obligation.

Example methods may further include where the storage accessible to the online software platform comprises the historical resource obligations incurred by one or more entities, including the entity, and wherein the storage further comprises authorizations for at least one of the one or more entities, including the entity. The method may further include wherein the storage accessible to the online software platform comprises one or more resource obligations, including the resource obligations associated with the transaction data. The method may further include where a resource obligation of the resource obligations is associated with an existing resource obligation rule, the method may further include receiving, at the online software platform, a new resource obligation rule associated with the resource obligation, comparing, by the online software platform, the new resource obligation rule with the existing resource obligation rule, based on a determination that the new resource obligation rule is different from the existing resource obligation rule, replacing the existing resource obligation rule with the new resource obligation rule, and, storing the new resource obligation rule at the storage accessible to the online software platform, wherein the new resource obligation is based at least in part on the new resource obligation rule.

The method may further include receiving, at the online software platform, a new resource obligation rule associated with the resource obligation, determining that the new resource obligation rule is different from an existing resource obligation rule associated with the resource obligation, and, generating an authorization alert to obtain authorization to prepare one or more data outputs based on the new resource obligation rule associated with the resource obligation.

The method may further include receiving, at the online software platform and via the authorization alert, one or more authorizations from one or more entities to prepare the one or more data outputs based on the new resource obligation rule associated with the resource obligation, and storing the one or more authorizations at the storage accessible to the online software platform.

The method may also include where the resource obligations associated with the transaction data comprise a tax liability, a fee liability, or combinations thereof. The method may further include where each of the existing resource obligation rule and the new resource obligation rule comprises a tax liability rate, a fee liability rate, or a combination thereof. The method may further include where the data output for the new resource obligation is a tax return.

The method may further include responsive to storing the received one or more authorizations at the storage accessible to the online software platform based on the authorization alert, determining that one or more of the new resource obligation rule requires registration with a domain for at least one of the one or more entities, determining, by the online software platform, whether data necessary to complete the registration is present at the storage, responsive to determining that a subset of data of the data necessary to complete the registration is not present at the storage, automatically modifying collection of transaction data received by the one or more entities to further comprise the subset of data, and, based on receiving the data necessary to complete the registration, including the subset of data, registering the at least one of the one or more entities with the domain. The method may also include where the domain comprises a government entity. The method may further comprise responsive to preparing, by the online software platform, the data output for the new resource obligation, transmitting the data output for the new resource obligation to a domain, the domain comprising a government entity.

In another example aspect, a system includes at least one processor, and, at least one non-transitory computer-readable storage medium storing instructions that, when executed by the at least one processor, cause the online software platform of the computing system to perform operations comprising receive transaction data for an entity, calculate resource obligations associated with the transaction data, compare the resource obligations with historical resource obligations incurred by the entity and stored in storage accessible to the online software platform, search for authorization to prepare data output based on the comparing indicating that at least one of the resource obligations is a new resource obligation for the entity, and, responsive to accessing the authorization, prepare the data output for the new resource obligation.

The system may also include where the storage accessible to the online software platform comprises the historical resource obligations incurred by one or more entities, including the entity, and wherein the storage further comprises authorizations of at least one of the one or more entities, including the entity. The system may also include where the storage accessible to the online software platform comprises one or more resource obligations, including the resource obligations associated with the transaction data.

The system may also include where the resource obligation is associated with an existing resource obligation rule, and wherein the instructions further cause the online software platform to receive a new resource obligation rule associated with the resource obligation, compare the new resource obligation rule with the existing resource obligation rule, based on a determination that the new resource obligation rule is different from the existing resource obligation rule, replace the existing resource obligation rule with the new resource obligation rule, and, store the new resource obligation rule at the storage accessible to the online software platform, wherein the new resource obligation may be based, at least in part, on the new resource obligation rule.

The system may also include receive a new resource obligation rule associated with the resource obligation, determine that the new resource obligation rule is different from an existing resource obligation rule associated with the resource obligation, and, generate an authorization alert to obtain authorization to prepare one or more data outputs based on the new resource obligation rule associated with the resource obligation.

The system may also include receive one or more authorizations from one or more entities to prepare the one or more data outputs based on the new resource obligation rule associated with the resource obligation, and, store the one or more authorizations at the storage accessible to the online software platform.

The system may also include where the resource obligations associated with the transaction data comprise a tax liability, a fee liability, or combinations thereof. The system may also include where each of the existing resource obligation rule and the new resource obligation rule comprises a tax liability rate, a fee liability rate, or a combination thereof. The system may also include where the data output for the new resource obligation is a tax return.

The system may also include responsive to storing the received one or more authorizations at the storage accessible to the online software platform based on the authorization alert, determine that one or more of the new resource obligation rule requires registration with a domain for at least one of the one or more entities, determine, by the online software platform, whether data necessary to complete the registration is present at the storage, responsive to determining that a subset of data of the data necessary to complete the registration is not present at the storage, automatically modify collection of transaction data received by the one or more entities to further comprise the subset of data, and, based on receiving the data necessary to complete the registration, including the subset of data, register the at least one of the one or more entities with the domain.

The system may also include where the domain comprises a government entity. The system may also include responsive to preparing, by the online software platform, the data output for the new resource obligation, transmitting the data output for the new resource obligation to a domain, the domain comprising a government entity.

In another example aspect, at least one non-transitory computer-readable storage medium is provided, the computer-readable storage medium including instructions that when executed by a computer, cause the computer to perform operations includes receive transaction data for an entity, calculate resource obligations associated with the transaction data, compare the resource obligations with historical resource obligations incurred by the entity and stored in storage accessible to the online software platform, search for authorization to prepare data output based on the comparing indicating that at least one of the resource obligations is a new resource obligation for the entity, and, responsive to accessing the authorization, prepare the data output for the new resource obligation.

The computer-readable storage medium may also include instructions where the storage accessible to the online software platform comprises the historical resource obligations incurred by one or more entities, including the entity, and wherein the storage further comprises authorizations of at least one of the one or more entities, including the entity.

The computer-readable storage medium may also include instructions where the storage accessible to the online software platform comprises one or more resource obligations, including the resource obligations associated with the transaction data.

The computer-readable storage medium may also include instructions where the resource obligation is associated with an existing resource obligation rule, and wherein the instructions further cause the computing system to receive a new resource obligation rule associated with the resource obligation, compare the new resource obligation rule with the existing resource obligation rule, based on a determination that the new resource obligation rule is different from the existing resource obligation rule, replace the existing resource obligation rule with the new resource obligation rule, and, store the new resource obligation rule at the storage accessible to the online software platform, wherein the new resource obligation may be based, at least in part, on the new resource obligation rule.

The computer-readable storage medium may also include instructions where receive a new resource obligation rule associated with the resource obligation, determine that the new resource obligation rule is different from an existing resource obligation rule associated with the resource obligation, and, generate an authorization alert to obtain authorization to prepare one or more data outputs based on the new resource obligation rule associated with the resource obligation.

The computer-readable storage medium may also include instructions where receive one or more authorizations from one or more entities to prepare the one or more data outputs based on the new resource obligation rule associated with the resource obligation, and, store the one or more authorizations at the storage accessible to the online software platform. The computer-readable storage medium may also include instructions where the resource obligations associated with the transaction data comprise a tax liability, a fee liability, or combinations thereof. The computer-readable storage medium may also include instructions where each of the existing resource obligation rule and the new resource obligation rule comprises a tax liability rate, a fee liability rate, or a combination thereof. The computer-readable storage medium may also include instructions where the data output for the new resource obligation is a tax return.

The computer-readable storage medium may also include instructions where responsive to storing the received one or more authorizations at the storage accessible to the online software platform based on the authorization alert, determine that one or more of the new resource obligation rule requires registration with a domain for at least one of the one or more entities, determine, by the online software platform, whether data necessary to complete the registration is present at the storage, responsive to determining that a subset of data of the data necessary to complete the registration is not present at the storage, automatically modify collection of transaction data received by the one or more entities to further comprise the subset of data, and, based on receiving the data necessary to complete the registration, including the subset of data, register the at least one of the one or more entities with the domain.

The computer-readable storage medium may also include instructions where the domain comprises a government entity. The computer-readable storage medium may also include instructions where responsive to preparing, by the online software platform, the data output for the new resource obligation, transmitting the data output for the new resource obligation to a domain, the domain comprising a government entity.

In the methods described herein, each operation can be performed as an affirmative act or operation of doing, or causing to happen, what is written that can take place. Such doing or causing to happen can be by the whole system or device, or just one or more components of it. It will be recognized that the methods and the operations may be implemented in a number of ways, including using systems, devices, and implementations described above. In addition, the order of operations is not constrained to what is shown, and different orders may be possible according to different embodiments. Examples of such alternate orderings may include overlapping, interleaved, interrupted, reordered, incremental, preparatory, supplemental, simultaneous, reverse, or other variant orderings, unless context dictates otherwise. Moreover, in certain embodiments, new operations may be added, or individual operations may be modified or deleted. The added operations can be, for example, from what is mentioned while primarily describing a different system, apparatus, device, or method.

Details have been included herein to provide a thorough understanding. In some instances, well-known aspects have not been described, in order to not obscure unnecessarily this description.

Some technologies or techniques described in this document may be known. Even then, however, it does not necessarily follow that it is known to apply such technologies or techniques as described in this document, or for the purposes described in this document.

This description includes one or more examples, but this fact does not limit how the technology may be practiced. Indeed, examples, instances, versions, or embodiments of the technology may be practiced according to what is described, or yet differently, and also in conjunction with other present or future technologies. Other such embodiments include combinations and sub-combinations of features described herein, including for example, embodiments that are equivalent to the following: providing or applying a feature in a different order than in a described embodiment; extracting an individual feature from one embodiment and inserting such feature into another embodiment; removing one or more features from an embodiment; or both removing a feature from an embodiment and adding a feature extracted from another embodiment, while providing the features incorporated in such combinations and sub-combinations.

A number of embodiments are possible, each including various combinations of elements. When one or more of the appended drawings – which are part of this specification – are taken together, they may present some embodiments with their elements in a manner so compact that these embodiments can be surveyed quickly. This is true even if these elements are described individually extensively in this text, and these elements are only optional in other embodiments.

What is claimed is:

1. A method comprising:
receiving, at an online software platform, transaction data for an entity;
calculating, by the online software platform, resource obligations associated with the transaction data;
comparing, by the online software platform, the resource obligations with historical resource obligations incurred by the entity and stored in storage accessible to the online software platform;
searching, by the online software platform, for authorization to prepare data output based on the comparing indicating that at least one of the resource obligations is a new resource obligation for the entity; and
responsive to accessing the authorization, preparing, by the online software platform, the data output for the new resource obligation.

2. The method of claim 1, wherein the storage accessible to the online software platform comprises the historical resource obligations incurred by one or more entities, including the entity, and wherein the storage further comprises authorizations for at least one of the one or more entities, including the entity.

3. The method of claim 1, wherein the storage accessible to the online software platform comprises one or more resource obligations, including the resource obligations associated with the transaction data.

4. The method of claim 1, wherein a resource obligation of the resource obligations is associated with an existing resource obligation rule, the method further comprising:
receiving, at the online software platform, a new resource obligation rule associated with the resource obligation;
comparing, by the online software platform, the new resource obligation rule with the existing resource obligation rule;
based on a determination that the new resource obligation rule is different from the existing resource obligation rule, replacing the existing resource obligation rule with the new resource obligation rule; and
storing the new resource obligation rule at the storage accessible to the online software platform, wherein the new resource obligation is based at least in part on the new resource obligation rule.

5. The method of claim 1, the method further comprising:
receiving, at the online software platform, a new resource obligation rule associated with the resource obligation;
determining that the new resource obligation rule is different from an existing resource obligation rule associated with the resource obligation; and
generating an authorization alert to obtain authorization to prepare one or more data outputs based on the new resource obligation rule associated with the resource obligation.

6. The method of claim 5, the method further comprising:
receiving, at the online software platform and via the authorization alert, one or more authorizations from one or more entities to prepare the one or more data outputs based on the new resource obligation rule associated with the resource obligation; and
storing the one or more authorizations at the storage accessible to the online software platform.

7. The method of claim 1, wherein the resource obligations associated with the transaction data comprise a tax liability, a fee liability, or combinations thereof.

8. The method of claim 4, wherein each of the existing resource obligation rule and the new resource obligation rule comprises a tax liability rate, a fee liability rate, or a combination thereof.

9. The method of claim 1, wherein the data output for the new resource obligation is a tax return.

10. The method of claim 6, the method further comprising:
responsive to storing the received one or more authorizations at the storage accessible to the online software platform based on the authorization alert, determining that one or more of the new resource obligation rules requires registration with a domain for at least one of the one or more entities;
determining, by the online software platform, whether data necessary to complete the registration is present at the storage;
responsive to determining that a subset of data of the data necessary to complete the registration is not present at the storage, automatically modifying collection of transaction data received by the one or more entities to further comprise the subset of data; and
based on receiving the data necessary to complete the registration, including the subset of data, registering the at least one of the one or more entities with the domain.

11. The method of claim 10, wherein the domain comprises a government entity.

12. The method of claim 1, the method further comprising:
responsive to preparing, by the online software platform, the data output for the new resource obligation, transmitting the data output for the new resource obligation to a domain, the domain comprising a government entity.

13. A computing system comprising an online software platform, the computing system comprising:
at least one processor; and
at least one non-transitory computer-readable storage medium storing instructions that, when executed by the at least one processor, cause the online software platform of the computing system to perform operations comprising:
receive transaction data for an entity;
calculate resource obligations associated with the transaction data;
compare the resource obligations with historical resource obligations incurred by the entity and stored in storage accessible to the online software platform;
search for authorization to prepare data output based on the comparing indicating that at least one of the resource obligations is a new resource obligation for the entity; and
responsive to accessing the authorization, prepare the data output for the new resource obligation.

14. The computing system comprising the online software platform of claim 13, wherein the storage accessible to the online software platform comprises the historical resource obligations incurred by one or more entities, including the entity, and wherein the storage further comprises authorizations of at least one of the one or more entities, including the entity.

15. The computing system comprising the online software platform of claim 13, wherein the storage accessible to the online software platform comprises one or more resource obligations, including the resource obligations associated with the transaction data.

16. The computing system comprising the online software platform of claim 13, wherein the resource obligation is associated with an existing resource obligation rule, and wherein the instructions further cause the online software platform to:
receive a new resource obligation rule associated with the resource obligation;
compare the new resource obligation rule with the existing resource obligation rule;
based on a determination that the new resource obligation rule is different from the existing resource obligation rule, replace the existing resource obligation rule with the new resource obligation rule; and
store the new resource obligation rule at the storage accessible to the online software platform, wherein the new resource obligation may be based, at least in part, on the new resource obligation rule.

17. The computing system comprising the online software platform of claim 13, wherein the instructions further cause the online software platform to:
receive a new resource obligation rule associated with the resource obligation;
determine that the new resource obligation rule is different from an existing resource obligation rule associated with the resource obligation; and
generate an authorization alert to obtain authorization to prepare one or more data outputs based on the new resource obligation rule associated with the resource obligation.

18. The computing system comprising the online software platform of claim 17, wherein the instructions further cause the online software platform to:
receive one or more authorizations from one or more entities to prepare the one or more data outputs based on the new resource obligation rule associated with the resource obligation; and
store the one or more authorizations at the storage accessible to the online software platform.

19. The computing system comprising the online software platform of claim 13, wherein the resource obligations associated with the transaction data comprise a tax liability, a fee liability, or combinations thereof.

20. The computing system comprising the online software platform of claim 16, wherein each of the existing resource obligation rule and the new resource obligation rule comprises a tax liability rate, a fee liability rate, or a combination thereof.

21. The computing system comprising the online software platform of claim 13, wherein the data output for the new resource obligation is a tax return.

22. The computing system comprising the online software platform of claim 18, wherein the instructions further cause the online software platform to:
responsive to storing the received one or more authorizations at the storage accessible to the online software platform based on the authorization alert, determine that one or more of the new resource obligation rule requires registration with a domain for at least one of the one or more entities;
determine, by the online software platform, whether data necessary to complete the registration is present at the storage;
responsive to determining that a subset of data of the data necessary to complete the registration is not present at the storage, automatically modify collection of transaction data received by the one or more entities to further comprise the subset of data; and
based on receiving the data necessary to complete the registration, including the subset of data, register the at least one of the one or more entities with the domain.

23. The computing system comprising the online software platform of claim 22, wherein the domain comprises a government entity.

24. The computing system comprising the online software platform of claim 13, wherein the instructions further cause the online software platform to:
responsive to preparing, by the online software platform, the data output for the new resource obligation, transmitting the data output for the new resource obligation to a domain, the domain comprising a government entity.

25. At least one non-transitory computer-readable storage medium including instructions that, when executed by a computing system comprising an online software platform, cause the computing system to:
receive transaction data for an entity;
calculate resource obligations associated with the transaction data;
compare the resource obligations with historical resource obligations incurred by the entity and stored in storage accessible to the online software platform;
search for authorization to prepare data output based on the comparing indicating that at least one of the resource obligations is a new resource obligation for the entity; and
responsive to accessing the authorization, prepare the data output for the new resource obligation.

26. The at least one non-transitory computer-readable storage medium of claim 25, wherein the storage accessible to the online software platform comprises the historical resource obligations incurred by one or more entities, including the entity, and wherein the storage further comprises authorizations of at least one of the one or more entities, including the entity.

27. The at least one non-transitory computer-readable storage medium of claim 25, wherein the storage accessible to the online software platform comprises one or more resource obligations, including the resource obligations associated with the transaction data.

28. The at least one non-transitory computer-readable storage medium of claim 25, wherein the resource obligation is associated with an existing resource obligation rule, and wherein the instructions further cause the computing system to:
receive a new resource obligation rule associated with the resource obligation;
compare the new resource obligation rule with the existing resource obligation rule;
based on a determination that the new resource obligation rule is different from the existing resource obligation rule, replace the existing resource obligation rule with the new resource obligation rule; and
store the new resource obligation rule at the storage accessible to the online software platform, wherein the new resource obligation may be based, at least in part, on the new resource obligation rule.

29. The at least one non-transitory computer-readable storage medium of claim 25, wherein the instructions further cause the computing system to:
receive a new resource obligation rule associated with the resource obligation;
determine that the new resource obligation rule is different from an existing resource obligation rule associated with the resource obligation; and
generate an authorization alert to obtain authorization to prepare one or more data outputs based on the new resource obligation rule associated with the resource obligation.

30. The at least one non-transitory computer-readable storage medium of claim 29, wherein the instructions further cause the computing system to:
receive one or more authorizations from one or more entities to prepare the one or more data outputs based on the new resource obligation rule associated with the resource obligation; and
store the one or more authorizations at the storage accessible to the online software platform.

31. The at least one non-transitory computer-readable storage medium of claim 25, wherein the resource obligations associated with the transaction data comprise a tax liability, a fee liability, or combinations thereof.

32. The at least one non-transitory computer-readable storage medium of claim 28, wherein each of the existing resource obligation rule and the new resource obligation rule comprises a tax liability rate, a fee liability rate, or a combination thereof.

33. The at least one non-transitory computer-readable storage medium of claim 25, wherein the data output for the new resource obligation is a tax return.

34. The at least one non-transitory computer-readable storage medium of claim 30, wherein the instructions further cause the computing system to:
responsive to storing the received one or more authorizations at the storage accessible to the online software platform based on the authorization alert, determine that one or more of the new resource obligation rule requires registration with a domain for at least one of the one or more entities;
determine, by the online software platform, whether data necessary to complete the registration is present at the storage;
responsive to determining that a subset of data of the data necessary to complete the registration is not present at the storage, automatically modify collection of transaction data received by the one or more entities to further comprise the subset of data; and
based on receiving the data necessary to complete the registration, including the subset of data, register the at least one of the one or more entities with the domain.

35. The at least one non-transitory computer-readable storage medium of claim 34, wherein the domain comprises a government entity.

36. The at least one non-transitory computer-readable storage medium of claim 25, wherein the instructions further cause the computing system to:
responsive to preparing, by the online software platform, the data output for the new resource obligation, transmitting the data output for the new resource obligation to a domain, the domain comprising a government entity.
